(19) United States
(12) Patent Application Publication
(10) Pub. No.: US 2022/0323915 A1
(43) Pub. Date: Oct. 13, 2022

(54) ULTRA-FINE BUBBLE-CONTAINING LIQUID GENERATING APPARATUS, ULTRA-FINE BUBBLE-CONTAINING LIQUID GENERATING METHOD, AND ULTRA-FINE BUBBLE-CONTAINING LIQUID

(71) Applicant: CANON KABUSHIKI KAISHA, Tokyo (JP)

(72) Inventors: Hiroaki Mihara, Tokyo (JP); Masahiko Kubota, Tokyo (JP); Akira Yamamoto, Kanagawa (JP); Ikuo Nakazawa, Kanagawa (JP); Hiroyuki Shimoyama, Hyogo (JP); Toshio Kashino, Kanagawa (JP)

(21) Appl. No.: 17/705,801

(22) Filed: Mar. 28, 2022

(30) Foreign Application Priority Data
Apr. 9, 2021 (JP) 2021-066520

(51) Int. Cl. B01F 23/2375; B01F 23/232; B01F 23/80; B01F 35/93; B01F 35/221

(52) U.S. Cl. CPC B01F 23/2375; B01F 23/232; B01F 23/811; B01F 35/93; B01F 35/2215; B01F 23/703

(57) ABSTRACT

An ultra-fine bubble-containing liquid generating apparatus (UFB-containing liquid generating apparatus) includes a dissolving unit that generates a gas dissolving liquid and an ultra-fine bubble generating unit that generates ultra-fine bubbles in the gas dissolving liquid. Additionally, the UFB-containing liquid generating apparatus includes a temperature controlling unit that controls at least one of temperatures of the dissolving unit and the ultra-fine bubble generating unit such that the temperature of the ultra-fine bubble generating unit is equal to or lower than the temperature of the dissolving unit.

### BACKGROUND OF THE INVENTION

### Field of the Invention

The present disclosure relates to an apparatus generating a liquid containing ultra-fine bubbles smaller than 1.0 μm in diameter, an ultra-fine bubble-containing liquid generating method, and an ultra-fine bubble-containing liquid.

### Description of the Related Art

Recently, there have been developed techniques for applying the features of fine bubbles such as microbubbles in micrometer-size in diameter and nanobubbles in nanometer-size in diameter. Especially, the utility of ultra-fine bubbles (hereinafter also referred to as “UFBs”) smaller than 1.0 μm in diameter has been confirmed in various fields.

Japanese Patent Laid-Open No. 2014-104441 describes an apparatus that generates fine bubbles by jetting a pressurized liquid in which a gas is pressurized and dissolved by a pressurized dissolution method from a nozzle.

Japanese Patent Laid-Open No. 2019-042732 discloses a technique of generating ultra-fine bubbles in a gas dissolving liquid by heating the gas dissolving liquid supplied from a gas dissolving unit (liquid supplying tank) with a heater provided in an ultra-fine bubble generating unit and generating film boiling.

### SUMMARY OF THE INVENTION

The present disclosure is an ultra-fine bubble-containing liquid generating apparatus includes: a dissolving unit that generates a gas dissolving liquid in which a predetermined gas is dissolved into a liquid; an ultra-fine bubble generating unit that generates an ultra-fine bubble in the gas dissolving liquid; and a temperature controlling unit that controls at least one of temperatures of the dissolving unit and the ultra-fine bubble generating unit such that the temperature of the ultra-fine bubble generating unit is equal to or lower than the temperature of the dissolving unit.

Further features of the present invention will become apparent from the following description of exemplary embodiments with reference to the attached drawings.

### BRIEF DESCRIPTION OF THE DRAWINGS

FIG. 1 is a diagram illustrating an example of a UFB generating apparatus;

FIG. 2 is a schematic configuration diagram of a pre-processing unit;

FIGS. 3A and 3B are a schematic configuration diagram of a dissolving unit and a diagram for describing the dissolving states in a liquid;

FIG. 4 is a schematic configuration diagram of a T-UFB generating unit;

FIGS. 5A and 5B are diagrams for describing details of a heating element;

FIGS. 6A and 6B are diagrams for describing the states of film boiling on the heating element;

FIGS. 7A to 7D are diagrams illustrating the states of generation of UFBs caused by expansion of a film boiling bubble;

FIGS. 8A to 8C are diagrams illustrating the states of generation of UFBs caused by shrinkage of the film boiling bubble;

FIGS. 9A to 9C are diagrams illustrating the states of generation of UFBs caused by reheating of the liquid;

FIGS. 10A and 10B are diagrams illustrating the states of generation of UFBs caused by shock waves made by disappearance of the bubble generated by the film boiling;

FIGS. 11A to 11C are diagrams illustrating a configuration example of a post-processing unit;

FIG. 12 is a schematic configuration diagram of a UFB generating apparatus in a first embodiment;

FIG. 13 is a vertical cross-sectional view illustrating a schematic configuration of a UFB generating unit in the first embodiment;

FIG. 14 is a schematic configuration diagram of a UFB generating apparatus in a second embodiment;

FIG. 15 is a cross-sectional view schematically illustrating a configuration of a UFB generating unit in the second embodiment;

FIG. 16 is a cross-sectional view schematically illustrating a coolant flow passage of a temperature controlling unit of the UFB generating unit in the second embodiment;

FIG. 17 is a schematic configuration diagram of a UFB generating apparatus in a third embodiment; and

FIG. 18 is a schematic configuration diagram of a UFB generating apparatus in a fourth embodiment.

### DESCRIPTION OF THE EMBODIMENTS

In the techniques disclosed in Japanese Patent Laid-Open Nos. 2014-104441 and 2019-042732, a gas is dissolved into a liquid before fine bubbles are generated. However, any of the patent literatures do not disclose a relationship between a temperature of a gas dissolving unit that dissolves a gas and a temperature of a bubble generating unit that generates fine bubbles. In general, in a case where the temperature is decreased, the gas dissolving amount into the liquid is increased. For this reason, in a case where a gas dissolving liquid in which a gas is dissolved to reach a saturation state by the gas dissolving unit is supplied to the bubble generating unit, if the temperature of the bubble generating unit is higher than the temperature of the gas dissolving unit, the gas dissolved in the gas dissolving liquid is precipitated again as air bubbles. Consequently, the dissolving amount of the gas in the gas dissolving liquid is reduced, and the amount of the bubbles generated by the bubble generating unit is accordingly reduced; thus, the efficiency of generating bubbles is reduced.

To deal with this, the present disclosure provides a technique that allows for efficient generation of ultra-fine bubbles.

### [Basic Configuration]

First, a basic configuration of a UFB generating apparatus using a film boiling phenomenon is described.

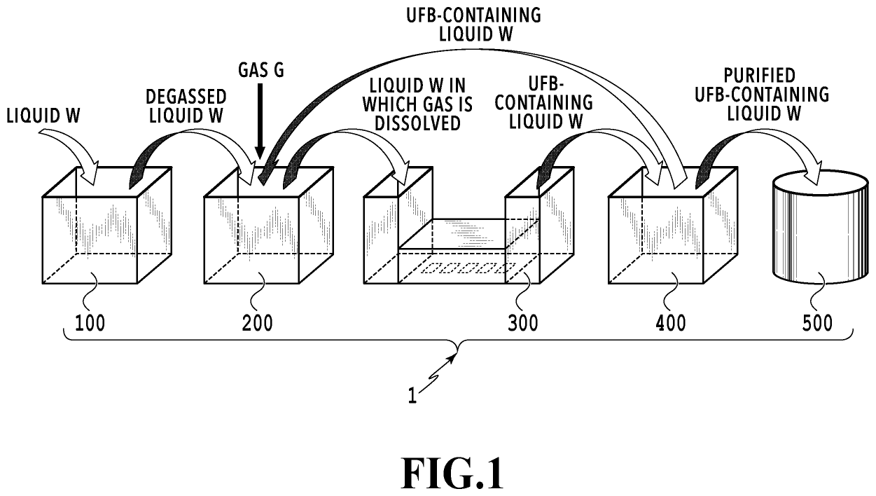

FIG. 1 is a diagram illustrating an example of a UFB generating apparatus applicable to the present invention. A UFB generating apparatus 1 of this embodiment includes a pre-processing unit 100, dissolving unit 200, a T-UFB generating unit 300, a post-processing unit 400, and a collecting unit 501. Each unit performs unique processing on a liquid W such as tap water supplied to the pre-processing unit 100 in the above order, and the thus-processed liquid W is collected as a T-UFB-containing liquid by the collecting unit 501. Functions and configurations of the units are described below. Although details are described later, UFBs generated by utilizing the film boiling caused by rapid heating are referred to as thermal-ultrafine bubbles (T-UFBs) in this specification.

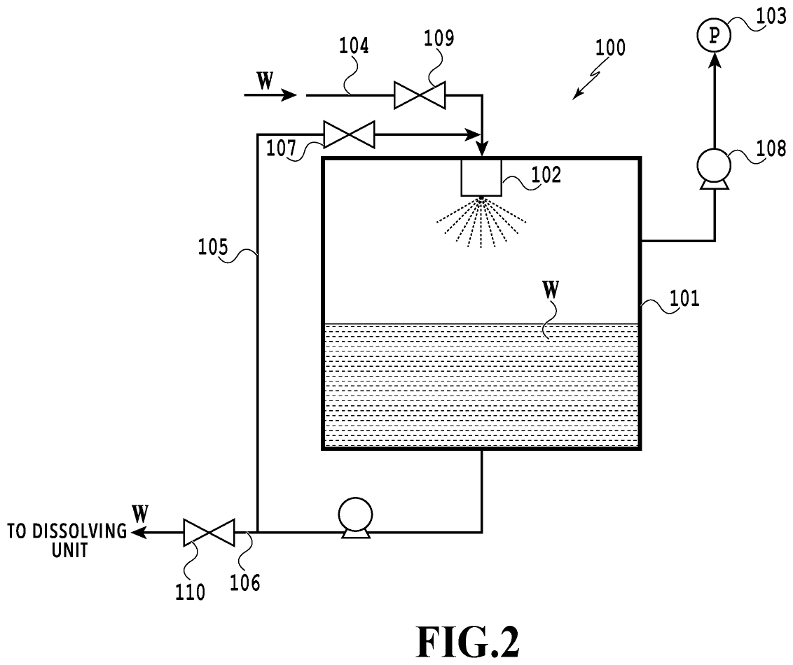

FIG. 2 is a schematic configuration diagram of the pre-processing unit 100. The pre-processing unit 100 of this embodiment performs a degassing treatment on the supplied liquid W. The pre-processing unit 100 mainly includes a degassing container 101, a shower head 102, a depressurizing pump 103, a liquid introduction passage 104, a liquid circulation passage 105, and a liquid discharge passage 106. For example, the liquid W such as tap water is supplied to the degassing container 101 from the liquid introduction passage 104 through a valve 109. In this process, the shower head 102 provided in the degassing container 101 sprays a mist of the liquid W in the degassing container 101. The shower head 102 is for prompting the gasification of the liquid W; however, a centrifugal and the like may be used instead as the mechanism for producing the gasification prompt effect.

When a certain amount of the liquid W is reserved in the degassing container 101 and then the depressurizing pump 103 is activated with all the valves closed, already-gasified gas components are discharged, and gasification and discharge of gas components dissolved in the liquid W are also prompted. In this process, the internal pressure of the degassing container 101 may be depressurized to around several hundreds to thousands of Pa (1.0 Torr to 10.0 Torr) while checking a manometer 108. The gases to be removed by the pre-processing unit 100 includes nitrogen, oxygen, argon, carbon dioxide, and so on, for example.

The above-described degassing processing can be repeatedly performed on the same liquid W by utilizing the liquid circulation passage 105. Specifically, the shower head 102 is operated with the valve 109 of the liquid introduction passage 104 and a valve 110 of the liquid discharge passage 106 closed and a valve 107 of the liquid circulation passage 105 opened. This allows the liquid W reserved in the degassing container 101 and degassed once to be resprayed in the degassing container 101 from the shower head 102. In addition, with the depressurizing pump 103 operated, the gasification processing by the shower head 102 and the degassing processing by the depressurizing pump 103 are repeatedly performed on the same liquid W. Every time the above processing utilizing the liquid circulation passage 105 is performed repeatedly, it is possible to decrease the gas components contained in the liquid W in stages. Once the liquid W degassed to a desired purity is obtained, the liquid W is transferred to the dissolving unit 200 through the liquid discharge passage 106 with the valve 110 opened.

FIG. 2 illustrates the degassing unit 100 that depressurizes the gas part to gasify the solute; however, the method of degassing the solution is not limited thereto. For example, a heating and boiling method for boiling the liquid W to gasify the solute may be employed, or a film degassing method for increasing the interface between the liquid and the gas using hollow fibers. A SEPAREL series (produced by DIC corporation) is commercially supplied as the degassing module using the hollow fibers. The SEPAREL series uses poly(4-methylpentene-1) (PMP) for the raw material of the hollow fibers and is used for removing air bubbles from ink and the like mainly supplied for a piezo head. In addition, two or more of an evacuating method, the heating and boiling method, and the film degassing method may be used together.

With the above-described degassing processing performed as pre-processing, it is possible to increase the purity and the solubility of a desired gas with respect to the liquid W in the dissolving processing described later. Additionally, it is possible to increase the purity of desired UFBs contained in the liquid W in the T-UFB generating unit described later. That is, it is possible to efficiently generate a UFB-containing liquid (ultra-fine bubble-containing liquid) with high purity by providing the pre-processing unit 100 to precede the dissolving unit 200 and the T-UFB generating unit 300.

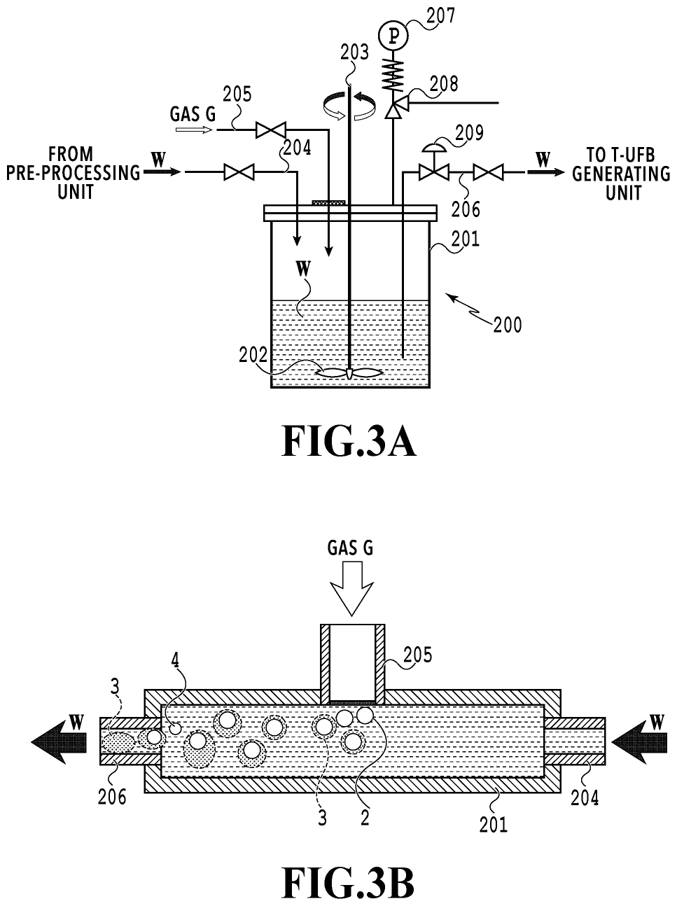

FIGS. 3A and 3B are a schematic configuration diagram of the dissolving unit 200 and a diagram for describing the dissolving states in the liquid. The dissolving unit 200 is a unit for dissolving a desired gas into the liquid W supplied from the pre-processing unit 100. The dissolving unit 200 of this embodiment mainly includes a dissolving container 201, a rotation shaft 203 provided with a rotation plate 202, a liquid introduction passage 204, a gas introduction passage 205, a liquid discharge passage 206, and a pressurizing pump 207.

The liquid W supplied from the pre-processing unit 100 is supplied and reserved into the dissolving container 201 through the liquid introduction passage 204. Meanwhile, a gas G is supplied to the dissolving container 201 through the gas introduction passage 205.

Once predetermined amounts of the liquid W and the gas G are reserved in the dissolving container 201, the pressurizing pump 207 is activated to increase the internal pressure of the dissolving container 201 to about 0.5 MPa. A safety valve 208 is arranged between the pressurizing pump 207 and the dissolving container 201. With the rotation plate 202 in the liquid rotated via the rotation shaft 203, the gas G supplied to the dissolving container 201 is transformed into air bubbles, and the contact area between the gas G and the liquid W is increased to prompt the dissolution into the liquid W. This operation is continued until the solubility of the gas G reaches almost the maximum saturation solubility. In this case, a unit for decreasing the temperature of the liquid may be provided to dissolve the gas as much as possible. When the gas is with low solubility, it is also possible to increase the internal pressure of the dissolving container 201 to 0.5 MPa or higher. In this case, the material and the like of the container need to be the optimum for safety sake.

Once the liquid W in which the components of the gas G are dissolved at a desired concentration is obtained, the liquid W is discharged through the liquid discharge passage 206 and supplied to the T-UFB generating unit 300. In this process, a back-pressure valve 209 adjusts the flow pressure of the liquid W to prevent excessive increase of the pressure during the supplying.

FIG. 3B is a diagram schematically illustrating the dissolving states of the gas G put in the dissolving container 201. An air bubble 2 containing the components of the gas G put in the liquid W is dissolved from a portion in contact with the liquid W. The air bubble 2 thus shrinks gradually, and a gas-dissolved liquid 3 then appears around the air bubble 2. Since the air bubble 2 is affected by the buoyancy, the air bubble 2 may be moved to a position away from the center of the gas-dissolved liquid 3 or be separated out from the gas-dissolved liquid 3 to become a residual air bubble 4. Specifically, in the liquid W to be supplied to the T-UFB generating unit 300 through the liquid discharge passage 206, there is a mix of the air bubbles 2 surrounded by the gas-dissolved liquids 3 and the air bubbles 2 and the gas-dissolved liquids 3 separated from each other.

The gas-dissolved liquid 3 in the drawings means “a region of the liquid W in which the dissolution concentration of the gas G mixed therein is relatively high.” In the gas components actually dissolved in the liquid W, the concentration of the gas components in the gas-dissolved liquid 3 is the highest at a portion surrounding the air bubble 2. In a case where the gas-dissolved liquid 3 is separated from the air bubble 2 the concentration of the gas components of the gas-dissolved liquid 3 is the highest at the center of the region, and the concentration is continuously decreased as away from the center. That is, although the region of the gas-dissolved liquid 3 is surrounded by a broken line in FIG. 3 for the sake of explanation, such a clear boundary does not actually exist. In addition, in the present invention, a gas that cannot be dissolved completely may be accepted to exist in the form of an air bubble in the liquid.

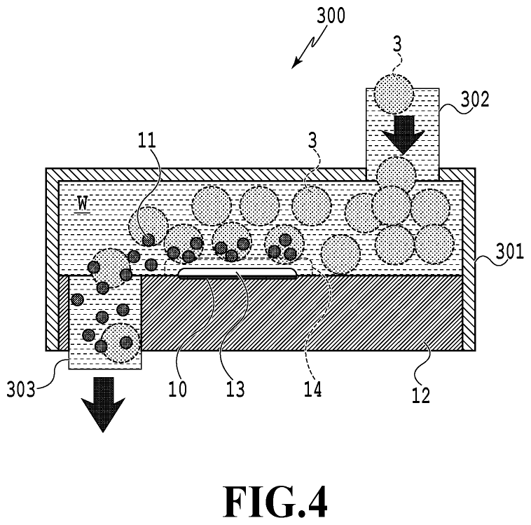

FIG. 4 is a schematic configuration diagram of the T-UFB generating unit 300. The T-UFB generating unit 300 mainly includes a chamber 301, a liquid introduction passage 302, and a liquid discharge passage 303. The flow from the liquid introduction passage 302 to the liquid discharge passage 303 through the chamber 301 is formed by a not-illustrated flow pump. Various pumps including a diaphragm pump, a gear pump, and a screw pump may be employed as the flow pump. In in the liquid W introduced from the liquid introduction passage 302, the gas-dissolved liquid 3 of the gas G put by the dissolving unit 200 is mixed.

An element substrate 12 provided with a heating element 10 is arranged on a bottom section of the chamber 301. With a predetermined voltage pulse applied to the heating element 10, a bubble 13 generated by the film boiling (hereinafter, also referred to as a film boiling bubble 13) is generated in a region in contact with the heating element 10. Then, an ultrafine bubble (UFB) 11 containing the gas G is generated caused by expansion and shrinkage of the film boiling bubble 13. As a result, a UFB-containing liquid W containing many UFBs 11 is discharged from the liquid discharge passage 303.

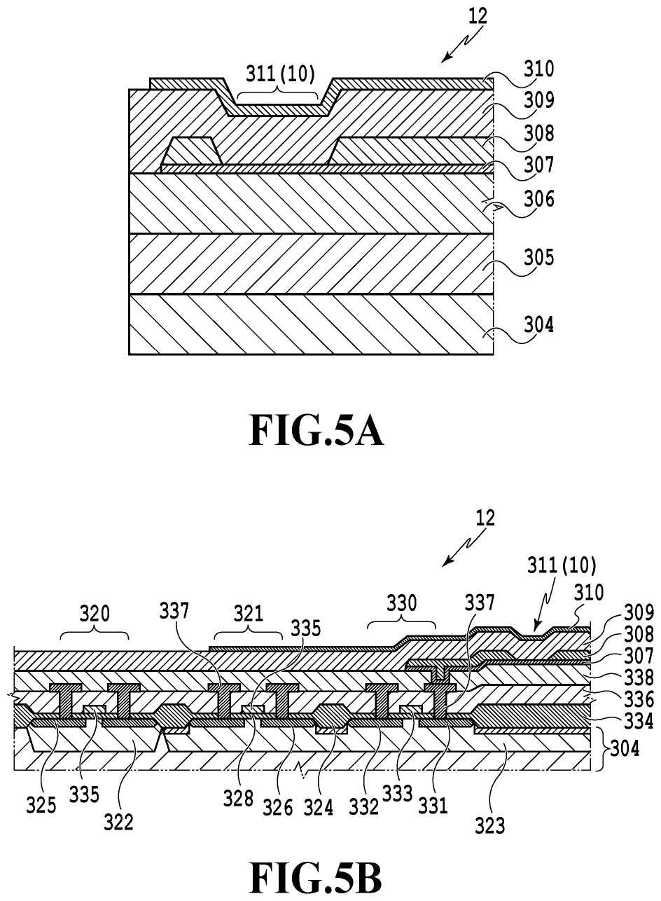

FIGS. 5A and 5B are diagrams for illustrating a detailed configuration of the heating element 10. FIG. 5A illustrates a closeup view of the heating element 10, and FIG. 5B illustrates a cross-sectional view of a wider region of the element substrate 12 including the heating element 10.

As illustrated in FIG. 5A, in the element substrate 12 of this embodiment, a thermal oxide film 305 as a heat-accumulating layer and an interlaminar film 306 also served as a heat-accumulating layer are laminated on a surface of a silicon substrate 304. An SiO₂ film or an SiN film may be used as the interlaminar film 306. A resistive layer 307 is formed on a surface of the interlaminar film 306, and a wiring 308 is partially formed on a surface of the resistive layer 307. An Al-alloy wiring of Al, Al—Si, Al—Cu, or the like may be used as the wiring 308. A protective layer 309 made of an SiO₂ film or an Si₃N₄ film is formed on surfaces of the wiring 308, the resistive layer 307, and the interlaminar film 306.

A cavitation-resistant film 310 for protecting the protective layer 309 from chemical and physical impacts due to the heat evolved by the resistive layer 307 is formed on a portion and around the portion on the surface of the protective layer 309, the portion corresponding to a heat-acting portion 311 that eventually becomes the heating element 10. A region on the surface of the resistive layer 307 in which the wiring 308 is not formed is the heat-acting portion 311 in which the resistive layer 307 evolves heat. The heating portion of the resistive layer 307 on which the wiring 308 is not formed functions as the heating element (heater) 10. As described above, the layers in the element substrate 12 are sequentially formed on the surface of the silicon substrate 304 by a semiconductor production technique, and the heat-acting portion 311 is thus provided on the silicon substrate 304.

The configuration illustrated in the drawings is an example, and various other configurations are applicable. For example, a configuration in which the laminating order of the resistive layer 307 and the wiring 308 is opposite, and a configuration in which an electrode is connected to a lower surface of the resistive layer 307 (so-called a plug electrode configuration) are applicable. In other words, as described later, any configuration may be applied as long as the configuration allows the heat-acting portion 311 to heat the liquid for generating the film boiling in the liquid.

FIG. 5B is an example of a cross-sectional view of a region including a circuit connected to the wiring 308 in the element substrate 12. An N-type well region 322 and a P-type well region 323 are partially provided in a top layer of the silicon substrate 304, which is a P-type conductor. AP-MOS 320 is formed in the N-type well region 322 and an N-MOS 321 is formed in the P-type well region 323 by introduction and diffusion of impurities by the ion implantation and the like in the general MOS process.

The P-MOS 320 includes a source region 325 and a drain region 326 formed by partial introduction of N-type or P-type impurities in a top layer of the N-type well region 322, a gate wiring 335, and so on. The gate wiring 335 is deposited on a part of a top surface of the N-type well region 322 excluding the source region 325 and the drain region 326, with a gate insulation film 328 of several hundreds of A in thickness interposed between the gate wiring 335 and the top surface of the N-type well region 322.

The N-MOS 321 includes the source region 325 and the drain region 326 formed by partial introduction of N-type or P-type impurities in a top layer of the P-type well region 323, the gate wiring 335, and so on. The gate wiring 335 is deposited on a part of a top surface of the P-type well region 323 excluding the source region 325 and the drain region 326, with the gate insulation film 328 of several hundreds of Å in thickness interposed between the gate wiring 335 and the top surface of the P-type well region 323. The gate wiring 335 is made of polysilicon of 3000 Å to 5000 Å in thickness deposited by the CVD method. A C-MOS logic is constructed with the P-MOS 320 and the N-MOS 321.

In the P-type well region 323, an N-MOS transistor 330 for driving an electrothermal conversion element (heating resistance element) is formed on a portion different from the portion including the N-MOS 321. The N-MOS transistor 330 includes a source region 332 and a drain region 331 partially provided in the top layer of the P-type well region 323 by the steps of introduction and diffusion of impurities, a gate wiring 333, and so on. The gate wiring 333 is deposited on a part of the top surface of the P-type well region 323 excluding the source region 332 and the drain region 331, with the gate insulation film 328 interposed between the gate wiring 333 and the top surface of the P-type well region 323.

In this example, the N-MOS transistor 330 is used as the transistor for driving the electrothermal conversion element. However, the transistor for driving is not limited to the N-MOS transistor 330, and any transistor may be used as long as the transistor has a capability of driving multiple electrothermal conversion elements individually and can implement the above-described fine configuration. Although the electrothermal conversion element and the transistor for driving the electrothermal conversion element are formed on the same substrate in this example, those may be formed on different substrates separately.

An oxide film separation region 324 is formed by field oxidation of 5000 Å to 10000 Å in thickness between the elements, such as between the P-MOS 320 and the N-MOS 321 and between the N-MOS 321 and the N-MOS transistor 330. The oxide film separation region 324 separates the elements. A portion of the oxide film separation region 324 corresponding to the heat-acting portion 311 functions as a heat-accumulating layer 334, which is the first layer on the silicon substrate 304.

An interlayer insulation film 336 including a PSG film, a BPSG film, or the like of about 7000 Å in thickness is formed by the CVD method on each surface of the elements such as the P-MOS 320, the N-MOS 321, and the N-MOS transistor 330. After the interlayer insulation film 336 is made flat by heat treatment, an Al electrode 337 as a first wiring layer is formed in a contact hole penetrating through the interlayer insulation film 336 and the gate insulation film 328. On surfaces of the interlayer insulation film 336 and the Al electrode 337, an interlayer insulation film 338 including an SiO₂ film of 10000 Å to 15000 Å in thickness is formed by a plasma CVD method. On the surface of the interlayer insulation film 338, a resistive layer 307 including a TaSiN film of about 500 Å in thickness is formed by a co-sputter method on portions corresponding to the heat-acting portion 311 and the N-MOS transistor 330. The resistive layer 307 is electrically connected with the Al electrode 337 near the drain region 331 via a through-hole formed in the interlayer insulation film 338. On the surface of the resistive layer 307, the wiring 308 of Al as a second wiring layer for a wiring to each electrothermal conversion element is formed. The protective layer 309 on the surfaces of the wiring 308, the resistive layer 307, and the interlayer insulation film 338 includes an SiN film of 3000 Å in thickness formed by the plasma CVD method. The cavitation-resistant film 310 deposited on the surface of the protective layer 309 includes a thin film of about 2000 Å in thickness, which is at least one metal selected from the group consisting of Ta, Fe, Ni, Cr, Ge, Ru, Zr, Ir, and the like. Various materials other than the above-described TaSiN such as TaN0.8, CrSiN, TaAl, WSiN, and the like can be applied as long as the material can generate the film boiling in the liquid.

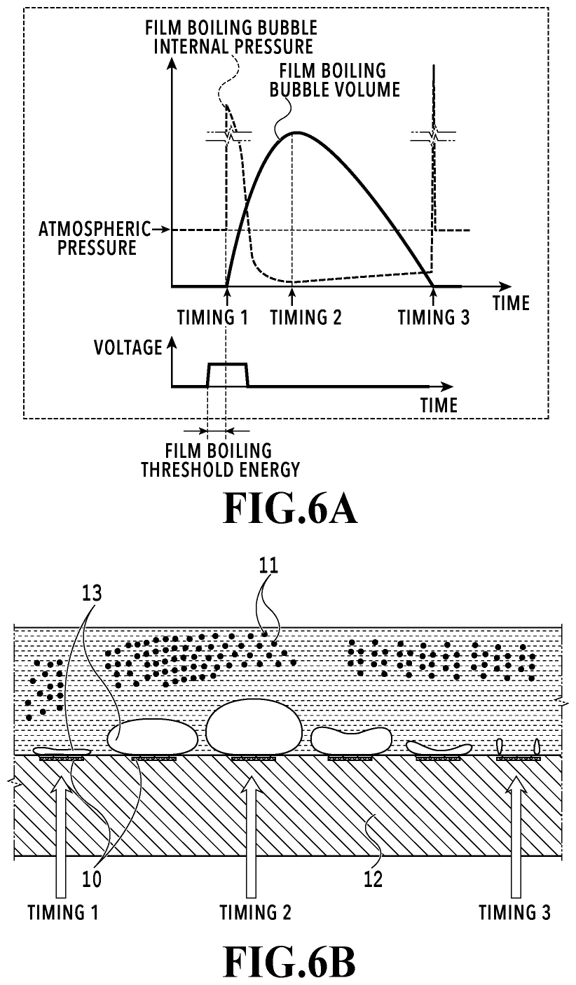

FIGS. 6A and 6B are diagrams illustrating the states of the film boiling when a predetermined voltage pulse is applied to the heating element 10. In this case, the case of generating the film boiling under atmospheric pressure is described. In FIG. 6A, the horizontal axis represents time. The vertical axis in the lower graph represents a voltage applied to the heating element 10, and the vertical axis in the upper graph represents the volume and the internal pressure of the film boiling bubble 13 generated by the film boiling. On the other hand, FIG. 6B illustrates the states of the film boiling bubble 13 in association with timings 1 to 3 shown in FIG. 6A. Each of the states is described below in chronological order. The UFBs 11 generated by the film boiling as described later are mainly generated near a surface of the film boiling bubble 13. The states illustrated in FIG. 6B are the states where the UFBs 11 generated by the generating unit 300 are resupplied to the dissolving unit 200 through the circulation route, and the liquid containing the UFBs 11 is resupplied to the liquid passage of the generating unit 300, as illustrated in FIG. 1.

Before a voltage is applied to the heating element 10, the atmospheric pressure is substantially maintained in the chamber 301. Once a voltage is applied to the heating element 10, the film boiling is generated in the liquid in contact with the heating element 10, and a thus-generated air bubble (hereinafter, referred to as the film boiling bubble 13) is expanded by a high pressure acting from inside (timing 1). A bubbling pressure in this process is expected to be around 8 to 10 MPa, which is a value close to a saturation vapor pressure of water.

The time for applying a voltage (pulse width) is around 0.5 μsec to 10.0 μsec, and the film boiling bubble 13 is expanded by the inertia of the pressure obtained in timing 1 even after the voltage application. However, a negative pressure generated with the expansion is gradually increased inside the film boiling bubble 13, and the negative pressure acts in a direction to shrink the film boiling bubble 13. After a while, the volume of the film boiling bubble 13 becomes the maximum in timing 2 when the inertial force and the negative pressure are balanced, and thereafter the film boiling bubble 13 shrinks rapidly by the negative pressure.

In the disappearance of the film boiling bubble 13, the film boiling bubble 13 disappears not in the entire surface of the heating element 10 but in one or more extremely small regions. For this reason, on the heating element 10, further greater force than that in the bubbling in timing 1 is generated in the extremely small region in which the film boiling bubble 13 disappears (timing 3).

The generation, expansion, shrinkage, and disappearance of the film boiling bubble 13 as described above are repeated every time a voltage pulse is applied to the heating element 10, and new UFBs 11 are generated each time.

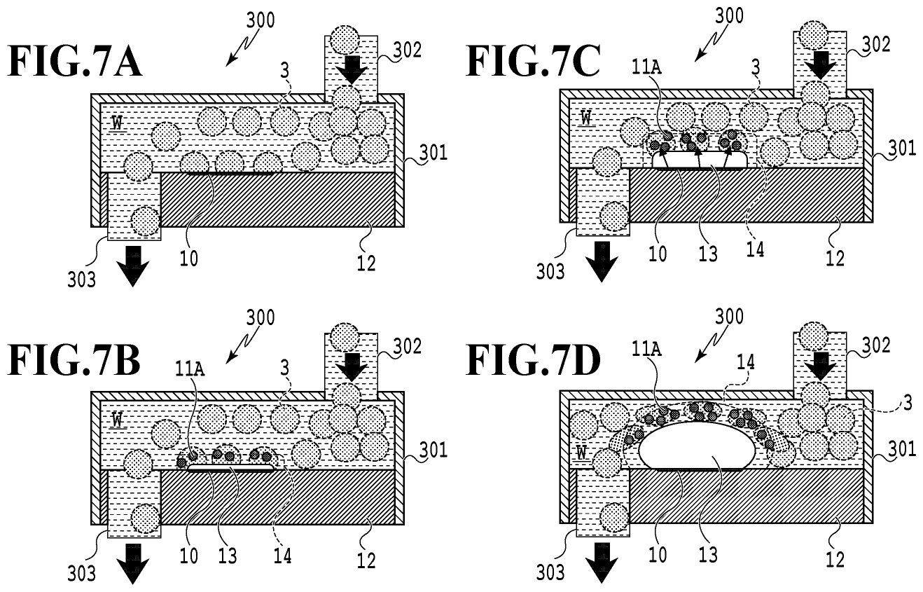

The states of generation of the UFBs 11 in each process of the generation, expansion, shrinkage, and disappearance of the film boiling bubble 13 are further described in detail with reference to FIGS. 7A to 10B.

FIGS. 7A to 7D are diagrams schematically illustrating the states of generation of the UFBs 11 caused by the generation and the expansion of the film boiling bubble 13. FIG. 7A illustrates the state before the application of a voltage pulse to the heating element 10. The liquid W in which the gas-dissolved liquids 3 are mixed flows inside the chamber 301.

FIG. 7B illustrates the state where a voltage is applied to the heating element 10, and the film boiling bubble 13 is evenly generated in almost all over the region of the heating element 10 in contact with the liquid W. When a voltage is applied, the surface temperature of the heating element 10 rapidly increases at a speed of 10° C./pec. The film boiling occurs at a time point when the temperature reaches almost 300° C., and the film boiling bubble 13 is thus generated.

Thereafter, the surface temperature of the heating element 10 keeps increasing to around 600 to 800° C. during the pulse application, and the liquid around the film boiling bubble 13 is rapidly heated as well. In FIG. 7B, a region of the liquid that is around the film boiling bubble 13 and to be rapidly heated is indicated as a not-yet-bubbling high temperature region 14. The gas-dissolved liquid 3 within the not-yet-bubbling high temperature region 14 exceeds the thermal dissolution limit and is vaporized to become the UFB. The thus-vaporized air bubbles have diameters of around 10 nm to 100 nm and large gas-liquid interface energy. Thus, the air bubbles float independently in the liquid W without disappearing in a short time. In this embodiment, the air bubbles generated by the thermal action from the generation to the expansion of the film boiling bubble 13 are called first UFBs 11A.

FIG. 7C illustrates the state where the film boiling bubble 13 is expanded. Even after the voltage pulse application to the heating element 10, the film boiling bubble 13 continues expansion by the inertia of the force obtained from the generation thereof, and the not-yet-bubbling high temperature region 14 is also moved and spread by the inertia. Specifically, in the process of the expansion of the film boiling bubble 13, the gas-dissolved liquid 3 within the not-yet-bubbling high temperature region 14 is vaporized as a new air bubble and becomes the first UFB 11A.

FIG. 7D illustrates the state where the film boiling bubble 13 has the maximum volume. As the film boiling bubble 13 is expanded by the inertia, the negative pressure inside the film boiling bubble 13 is gradually increased along with the expansion, and the negative pressure acts to shrink the film boiling bubble 13. At a time point when the negative pressure and the inertial force are balanced, the volume of the film boiling bubble 13 becomes the maximum, and then the shrinkage is started.

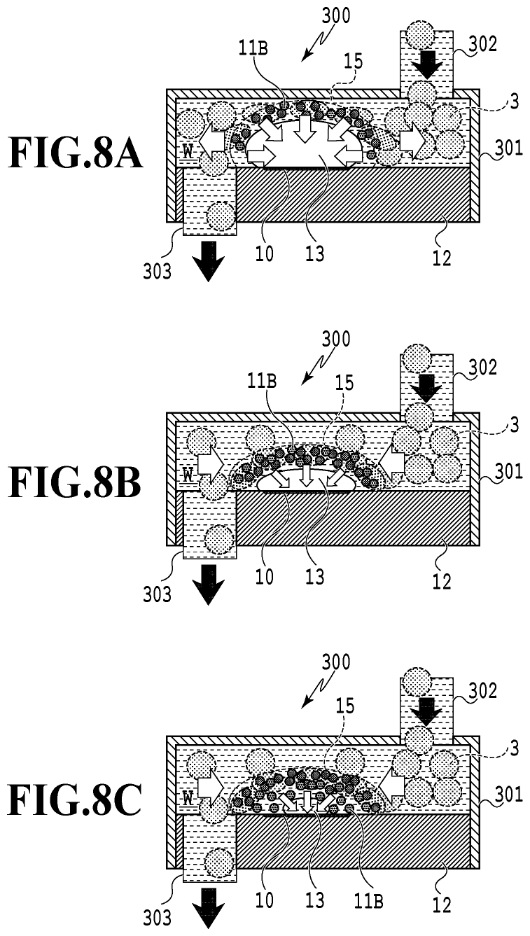

FIGS. 8A to 8C are diagrams illustrating the states of generation of the UFBs 11 caused by the shrinkage of the film boiling bubble 13. FIG. 8A illustrates the state where the film boiling bubble 13 starts shrinking. Although the film boiling bubble 13 starts shrinking, the surrounding liquid W still has the inertial force in the expansion direction. Because of this, the inertial force acting in the direction of going away from the heating element 10 and the force going toward the heating element 10 caused by the shrinkage of the film boiling bubble 13 act in a surrounding region extremely close to the film boiling bubble 13, and the region is depressurized. The region is indicated in the drawings as a not-yet-bubbling negative pressure region 15.

The gas-dissolved liquid 3 within the not-yet-bubbling negative pressure region 15 exceeds the pressure dissolution limit and is vaporized to become an air bubble. The thus-vaporized air bubbles have diameters of about 100 nm and thereafter float independently in the liquid W without disappearing in a short time. In this embodiment, the air bubbles vaporized by the pressure action during the shrinkage of the film boiling bubble 13 are called the second UFBs 11B.

FIG. 8B illustrates a process of the shrinkage of the film boiling bubble 13. The shrinking speed of the film boiling bubble 13 is accelerated by the negative pressure, and the not-yet-bubbling negative pressure region 15 is also moved along with the shrinkage of the film boiling bubble 13. Specifically, in the process of the shrinkage of the film boiling bubble 13, the gas-dissolved liquids 3 within a part over the not-yet-bubbling negative pressure region 15 are precipitated one after another and become the second UFBs 11B.

FIG. 8C illustrates the state immediately before the disappearance of the film boiling bubble 13. Although the moving speed of the surrounding liquid W is also increased by the accelerated shrinkage of the film boiling bubble 13, a pressure loss occurs due to a flow passage resistance in the chamber 301. As a result, the region occupied by the not-yet-bubbling negative pressure region 15 is further increased, and a number of the second UFBs 11B are generated.

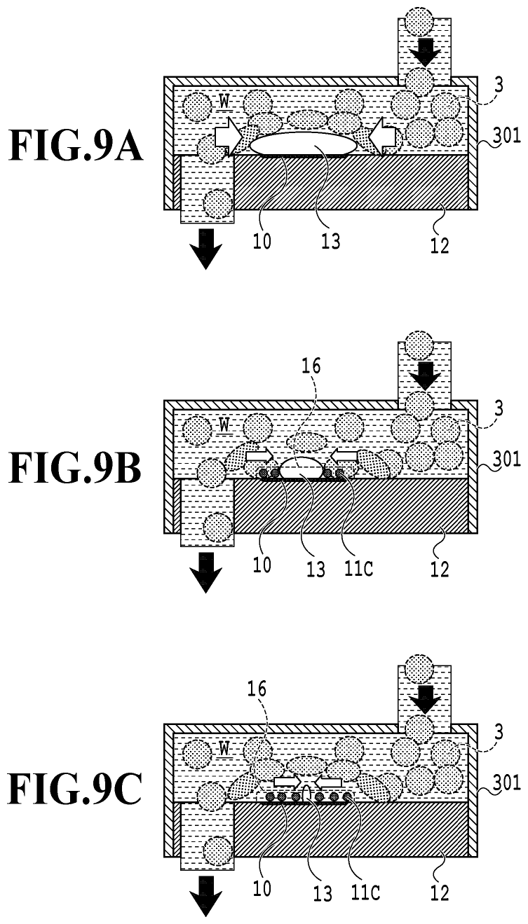

FIGS. 9A to 9C are diagrams illustrating the states of generation of the UFBs by reheating of the liquid W during the shrinkage of the film boiling bubble 13. FIG. 9A illustrates the state where the surface of the heating element 10 is covered with the shrinking film boiling bubble 13.

FIG. 9B illustrates the state where the shrinkage of the film boiling bubble 13 has progressed, and a part of the surface of the heating element 10 comes in contact with the liquid W. In this state, there is heat left on the surface of the heating element 10, but the heat is not high enough to cause the film boiling even if the liquid W comes in contact with the surface. A region of the liquid to be heated by coming in contact with the surface of the heating element 10 is indicated in the drawings as a not-yet-bubbling reheated region 16. Although the film boiling is not made, the gas-dissolved liquid 3 within the not-yet-bubbling reheated region 16 exceeds the thermal dissolution limit and is vaporized. In this embodiment, the air bubbles generated by the reheating of the liquid W during the shrinkage of the film boiling bubble 13 are called the third UFBs 11C.

FIG. 9C illustrates the state where the shrinkage of the film boiling bubble 13 has further progressed. The smaller the film boiling bubble 13, the greater the region of the heating element 10 in contact with the liquid W, and the third UFBs 11C are generated until the film boiling bubble 13 disappears.

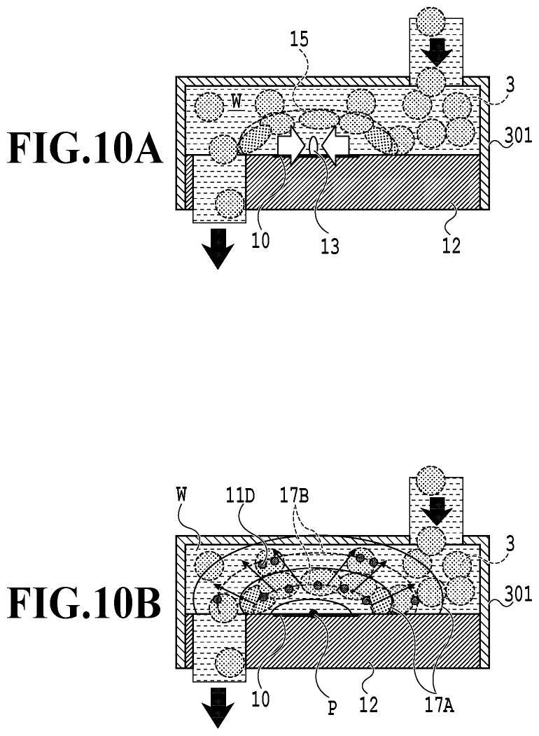

FIGS. 10A and 10B are diagrams illustrating the states of generation of the UFBs caused by an impact from the disappearance of the film boiling bubble 13 generated by the film boiling (that is, a type of cavitation). FIG. 10A illustrates the state immediately before the disappearance of the film boiling bubble 13. In this state, the film boiling bubble 13 shrinks rapidly by the internal negative pressure, and the not-yet-bubbling negative pressure region 15 surrounds the film boiling bubble 13.

FIG. 10B illustrates the state immediately after the film boiling bubble 13 disappears at a point P. When the film boiling bubble 13 disappears, acoustic waves ripple concentrically from the point P as a starting point due to the impact of the disappearance. The acoustic wave is a collective term of an elastic wave that is propagated through anything regardless of gas, liquid, and solid. In this embodiment, compression waves of the liquid W, which are a high pressure surface 17A and a low pressure surface 17B of the liquid W, are propagated alternately.

In this case, the gas-dissolved liquid 3 within the not-yet-bubbling negative pressure region 15 is resonated by the shock waves made by the disappearance of the film boiling bubble 13, and the gas-dissolved liquid 3 exceeds the pressure dissolution limit and the phase transition is made in timing when the low pressure surface 17B passes therethrough. Specifically, a number of air bubbles are vaporized in the not-yet-bubbling negative pressure region 15 simultaneously with the disappearance of the film boiling bubble 13. In this embodiment, the air bubbles generated by the shock waves made by the disappearance of the film boiling bubble 13 are called fourth UFBs 11D.

The fourth UFBs 11D generated by the shock waves made by the disappearance of the film boiling bubble 13 suddenly appear in an extremely short time (1 μS or less) in an extremely narrow thin film-shaped region. The diameter is sufficiently smaller than that of the first to third UFBs, and the gas-liquid interface energy is higher than that of the first to third UFBs. For this reason, it is considered that the fourth UFBs 11D have different characteristics from the first to third UFBs 11A to 11C and generate different effects.

Additionally, the fourth UFBs 11D are evenly generated in many parts of the region of the concentric sphere in which the shock waves are propagated, and the fourth UFBs 11D evenly exist in the chamber 301 from the generation thereof. Although many first to third UFBs already exist in the timing of the generation of the fourth UFBs 11D, the presence of the first to third UFBs does not affect the generation of the fourth UFBs 11D greatly. It is also considered that the first to third UFBs do not disappear due to the generation of the fourth UFBs 11D.

As described above, it is expected that the UFBs 11 are generated in the multiple stages from the generation to the disappearance of the film boiling bubble 13 by the heat generation of the heating element 10. Although the above example illustrates the stages to the disappearance of the film boiling bubble 13, the way of generating the UFBs is not limited thereto. For example, with the generated film boiling bubble 13 communicating with the atmospheric air before the bubble disappearance, the UFBs can be generated also if the film boiling bubble 13 does not reach the disappearance.

Next, remaining properties of the UFBs are described. The higher the temperature of the liquid, the lower the dissolution properties of the gas components, and the lower the temperature, the higher the dissolution properties of the gas components. In other words, the phase transition of the dissolved gas components is prompted and the generation of the UFBs becomes easier as the temperature of the liquid is higher. The temperature of the liquid and the solubility of the gas are in the inverse relationship, and the gas exceeding the saturation solubility is transformed into air bubbles and appeared in the liquid as the liquid temperature increases.

Therefore, when the temperature of the liquid rapidly increases from normal temperature, the dissolution properties are decreased without stopping, and the generation of the UFBs starts. The thermal dissolution properties are decreased as the temperature increases, and a number of the UFBs are generated.

Conversely, when the temperature of the liquid decreases from normal temperature, the dissolution properties of the gas are increased, and the generated UFBs are more likely to be liquefied. However, such temperature is sufficiently lower than normal temperature. Additionally, since the once generated UFBs have a high internal pressure and large gas-liquid interface energy even when the temperature of the liquid decreases, it is highly unlikely that there is exerted a sufficiently high pressure to break such a gas-liquid interface. In other words, the once generated UFBs do not disappear easily as long as the liquid is stored at normal temperature and normal pressure.

In this embodiment, the first UFBs 11A described with FIGS. 7A to 7C and the third UFBs 11C described with FIGS. 9A to 9C can be described as UFBs that are generated by utilizing such thermal dissolution properties of gas.

On the other hand, in the relationship between the pressure and the dissolution properties of liquid, the higher the pressure of the liquid, the higher the dissolution properties of the gas, and the lower the pressure, the lower the dissolution properties. In other words, the phase transition to the gas of the gas-dissolved liquid dissolved in the liquid is prompted and the generation of the UFBs becomes easier as the pressure of the liquid is lower. Once the pressure of the liquid becomes lower than normal pressure, the dissolution properties are decreased instantly, and the generation of the UFBs starts. The pressure dissolution properties are decreased as the pressure decreases, and a number of the UFBs are generated.

Conversely, when the pressure of the liquid increases to be higher than normal temperature, the dissolution properties of the gas are increased, and the generated UFBs are more likely to be liquefied. However, such pressure is sufficiently higher than the atmospheric pressure. Additionally, since the once generated UFBs have a high internal pressure and large gas-liquid interface energy even when the pressure of the liquid increases, it is highly unlikely that there is exerted a sufficiently high pressure to break such a gas-liquid interface. In other words, the once generated UFBs do not disappear easily as long as the liquid is stored at normal temperature and normal pressure.

In this embodiment, the second UFBs 11B described with FIGS. 8A to 8C and the fourth UFBs 11D described with FIGS. 10A to 10C can be described as UFBs that are generated by utilizing such pressure dissolution properties of gas.

Those first to fourth UFBs generated by different causes are described individually above; however, the above-described generation causes occur simultaneously with the event of the film boiling. Thus, at least two types of the first to the fourth UFBs may be generated at the same time, and these generation causes may cooperate to generate the UFBs. It should be noted that it is common for all the generation causes to be induced by the volume change of the film boiling bubble generated by the film boiling phenomenon. In this specification, the method of generating the UFBs by utilizing the film boiling caused by the rapid heating as described above is referred to as a thermal-ultrafine bubble (T-UFB) generating method. Additionally, the UFBs generated by the T-UFB generating method are referred to as T-UFBs, and the liquid containing the T-UFBs generated by the T-UFB generating method is referred to as a T-UFB-containing liquid.

Almost all the air bubbles generated by the T-UFB generating method are 1.0 or less, and milli-bubbles and microbubbles are unlikely to be generated. That is, the T-UFB generating method allows dominant and efficient generation of the UFBs. Additionally, the T-UFBs generated by the T-UFB generating method have larger gas-liquid interface energy than that of the UFBs generated by a conventional method, and the T-UFBs do not disappear easily as long as being stored at normal temperature and normal pressure. Moreover, even if new T-UFBs are generated by new film boiling, it is possible to prevent disappearance of the already generated T-UFBs due to the impact from the new generation. That is, it can be said that the number and the concentration of the T-UFBs contained in the T-UFB-containing liquid have the hysteresis properties depending on the number of times the film boiling is made in the T-UFB-containing liquid. In other words, it is possible to adjust the concentration of the T-UFBs contained in the T-UFB-containing liquid by controlling the number of the heating elements provided in the T-UFB generating unit 300 and the number of the voltage pulse application to the heating elements.

Reference to FIG. 1 is made again. Once the T-UFB-containing liquid W with a desired UFB concentration is generated in the T-UFB generating unit 300, the UFB-containing liquid W is supplied to the post-processing unit 400.

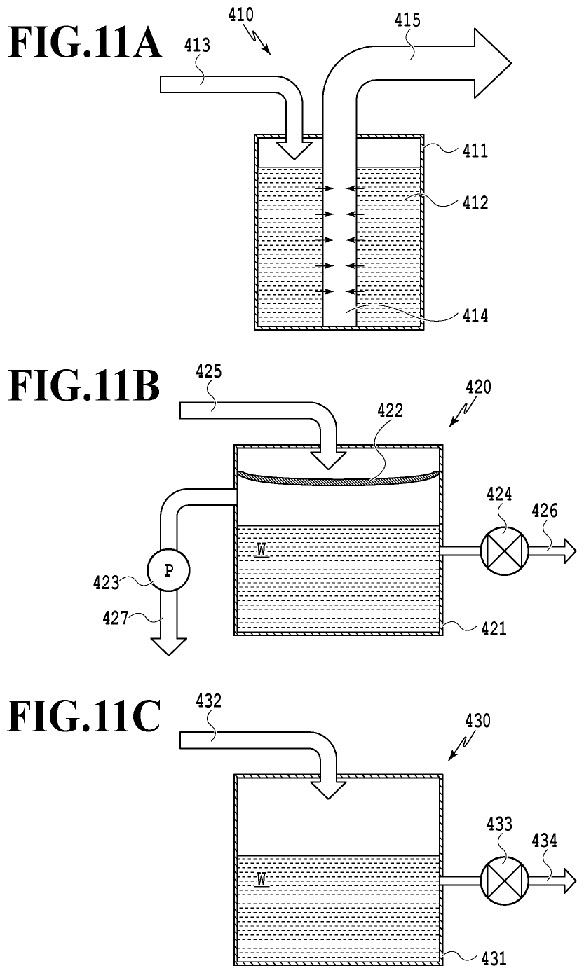

FIGS. 11A to 11C are diagrams illustrating configuration examples of the post-processing unit 400 of this embodiment. The post-processing unit 400 of this embodiment removes impurities in the UFB-containing liquid W in stages in the order from inorganic ions, organic substances, and insoluble solid substances.

FIG. 11A illustrates a first post-processing mechanism 410 that removes the inorganic ions. The first post-processing mechanism 410 includes an exchange container 411, cation exchange resins 412, a liquid introduction passage 413, a collecting pipe 414, and a liquid discharge passage 415. The exchange container 411 stores the cation exchange resins 412. The UFB-containing liquid W generated by the T-UFB generating unit 300 is injected to the exchange container 411 through the liquid introduction passage 413 and absorbed into the cation exchange resins 412 such that the cations as the impurities are removed. Such impurities include metal materials peeled off from the element substrate 12 of the T-UFB generating unit 300, such as SiO₂, SiN, SiC, Ta, Al₂O₃, Ta₂O₅, and Ir.

The cation exchange resins 412 are synthetic resins in which a functional group (ion exchange group) is introduced in a high polymer matrix having a three-dimensional network, and the appearance of the synthetic resins are spherical particles of around 0.4 to 0.7 mm. A general high polymer matrix is the styrene-divinylbenzene copolymer, and the functional group may be that of methacrylic acid series and acrylic acid series, for example. However, the above material is an example. As long as the material can remove desired inorganic ions effectively, the above material can be changed to various materials. The UFB-containing liquid W absorbed in the cation exchange resins 412 to remove the inorganic ions is collected by the collecting pipe 414 and transferred to the next step through the liquid discharge passage 415.

FIG. 11B illustrates a second post-processing mechanism 420 that removes the organic substances. The second post-processing mechanism 420 includes a storage container 421, a filtration filter 422, a vacuum pump 423, a valve 424, a liquid introduction passage 425, a liquid discharge passage 426, and an air suction passage 427. Inside of the storage container 421 is divided into upper and lower two regions by the filtration filter 422. The liquid introduction passage 425 is connected to the upper region of the upper and lower two regions, and the air suction passage 427 and the liquid discharge passage 426 are connected to the lower region thereof. Once the vacuum pump 423 is driven with the valve 424 closed, the air in the storage container 421 is discharged through the air suction passage 427 to make the pressure inside the storage container 421 negative pressure, and the UFB-containing liquid W is thereafter introduced from the liquid introduction passage 425. Then, the UFB-containing liquid W from which the impurities are removed by the filtration filter 422 is reserved into the storage container 421.

The impurities removed by the filtration filter 422 include organic materials that may be mixed at a tube or each unit, such as organic compounds including silicon, siloxane, and epoxy, for example. A filter film usable for the filtration filter 422 includes a filter of a sub-μm-mesh (a filter of 1 μm or smaller in mesh diameter) that can remove bacteria, and a filter of a nm-mesh that can remove virus.

After a certain amount of the UFB-containing liquid W is reserved in the storage container 421, the vacuum pump 423 is stopped and the valve 424 is opened to transfer the T-UFB-containing liquid in the storage container 421 to the next step through the liquid discharge passage 426. Although the vacuum filtration method is employed as the method of removing the organic impurities herein, a gravity filtration method and a pressurized filtration can also be employed as the filtration method using a filter, for example.

FIG. 11C illustrates a third post-processing mechanism 430 that removes the insoluble solid substances. The third post-processing mechanism 430 includes a precipitation container 431, a liquid introduction passage 432, a valve 433, and a liquid discharge passage 434.

First, a predetermined amount of the UFB-containing liquid W is reserved into the precipitation container 431 through the liquid introduction passage 432 with the valve 433 closed, and leaving it for a while. Meanwhile, the solid substances in the UFB-containing liquid W are precipitated onto the bottom of the precipitation container 431 by gravity. Among the bubbles in the UFB-containing liquid, relatively large bubbles such as microbubbles are raised to the liquid surface by the buoyancy and also removed from the UFB-containing liquid. After a lapse of sufficient time, the valve 433 is opened, and the UFB-containing liquid W from which the solid substances and large bubbles are removed is transferred to the collecting unit 501 through the liquid discharge passage 434.

Reference to FIG. 1 is made again. The T-UFB-containing liquid W from which the impurities are removed by the post-processing unit 400 may be directly transferred to the collecting unit 501 or may be put back to the dissolving unit 200 again. In the latter case, the gas dissolution concentration of the T-UFB-containing liquid W that is decreased due to the generation of the T-UFBs can be compensated to the saturated state again by the dissolving unit 200. If new T-UFBs are generated by the T-UFB generating unit 300 after the compensation, it is possible to further increase the concentration of the UFBs contained in the T-UFB-containing liquid with the above-described properties. That is, it is possible to increase the concentration of the contained UFBs by the number of circulations through the dissolving unit 200, the T-UFB generating unit 300, and the post-processing unit 400, and it is possible to transfer the UFB-containing liquid W to the collecting unit 501 after a predetermined concentration of the contained UFBs is obtained.

Here, an effect of putting back the generated T-UFB-containing liquid W to the dissolving unit 200 again is simply described in accordance with details of specific testing performed by the present disclosures. First, in the T-UFB generating unit 300, 10000 pieces of the heating elements 10 were arranged on the element substrate 12. Industrial pure water was used as the liquid W and was flowed in the chamber 301 of the T-UFB generating unit 300 at a flow rate of 1.0 liter/hour. I this state, a voltage pulse with a voltage of 24 V and a pulse width of 1.0 μs was applied at a driving frequency of 10 KHz to the individual heating elements.

In a case where the generated T-UFB-containing liquid W was collected by the collecting unit 500 without putting back to the dissolving unit 200, that is, in a case where the number of circulation was one time, 3.6 billion pieces per mL of the UFBs were confirmed in the T-UFB-containing liquid W collected by the collecting unit 501. On the other hand, in a case where the operation of putting back the T-UFB-containing liquid W to the dissolving unit 200 was performed nine times, that is, in a case where the number of circulation was ten times, 36 billion pieces per mL of the UFBs were confirmed in the T-UFB-containing liquid W collected by the collecting unit 500. That is, it was confirmed that the UFB-containing concentration is increased in the proportion of the number of circulation. The number density of the UFBs as described above was obtained by counting the UFBs smaller than 1.0 μm in diameter contained in the UFB-containing liquid W of a predetermined volume by using a measuring instrument (model number SALD-7500) manufactured by SHIMADZU CORPORATION.

The collecting unit 500 collects and stores the UFB-containing liquid W transferred from the post-processing unit 400. The T-UFB-containing liquid collected by the collecting unit 500 is a UFB-containing liquid with high purity from which various impurities are removed.

In the collecting unit 500, the UFB-containing liquid W may be classified by the size of the T-UFBs by performing some stages of filtration processing. Since it is expected that the temperature of the T-UFB-containing liquid W obtained by the T-UFB generating method is higher than normal temperature, the collecting unit 500 may be provided with a cooling unit. The cooling unit may be provided as a part of the post-processing unit 400.

The schematic description of the UFB generating apparatus 1 is given above; however, it is needless to say that the illustrated multiple units can be changed, and not all of them need to be prepared. Depending on the type of the liquid W and the gas G to be used and the intended use of the T-UFB-containing liquid to be generated, a part of the above-described units may be omitted, or another unit other than the above-described units may be added.

For example, when the gas to be contained by the UFBs is the atmospheric air, the degassing unit as the pre-processing unit 100 and the dissolving unit 200 can be omitted. On the other hand, when multiple kinds of gases are desired to be contained by the UFBs, another dissolving unit 200 may be added.

The functions of some units illustrated in FIG. 1 can be integrated into a single unit. For example, the dissolving unit 200 and the T-UFB generating unit 300 can be integrated by arranging the heating element 10 in the dissolving container 201 illustrated in FIGS. 3A and 3B. Specifically, an electrode type T-UFB module is disposed in a gas dissolving container (high-pressure chamber), and multiple heaters arranged in the module are driven to make film boiling. Such a configuration allows a single unit to generate T-UFBs containing a gas while dissolving the gas therein. In this case, with the T-UFB module arranged on a base of the gas dissolving container, a Marangoni flow occurs due to the heat generated by the heaters, and the liquid in the container can be agitated to some extent without providing a circulating and agitating unit.

The removing units for removing the impurities as illustrated in FIGS. 11A to 11C may be provided upstream of the T-UFB generating unit 300 as a part of the pre-processing unit or may be provided both upstream and downstream thereof. In a case where the liquid to be supplied to the UFB generating apparatus is tap water, rain water, contaminated water, or the like, there may be included organic and inorganic impurities in the liquid. If such a liquid W including the impurities is supplied to the T-UFB generating unit 300, there occurs a risk of deteriorating the heating element 10 and inducing the salting-out phenomenon. With the mechanisms as illustrated in FIGS. 11A to 11C provided upstream of the T-UFB generating unit 300, it is possible to remove the above-described impurities previously and to more efficiently generate a UFB-containing liquid with higher purity.

Particularly, in a case where an impurity removing unit using an ion-exchange resin illustrated in FIG. 11A is provided in the pre-processing unit, arrangement an anion-exchange resin contributes efficient generation of T-UFB water. This is because it has been confirmed that the ultra-fine bubbles generated by the T-UFB generating unit 300 have a negative charge. Accordingly, T-UFB water with high purity can be generated by removing the impurities having the same negative charges in the pre-processing unit. As the anion-exchange resin used herein, both the strongly basic anion-exchange resin having quaternary ammonium group and weakly basic anion-exchange resin having primary to tertiary amine group are appropriate. Which of these is appropriate depends on the type of the liquid to be used. Usually, in a case of using tap water, pure water, or the like as the liquid, the function of removing the impurities can be fulfilled sufficiently by using only the latter weakly basic anion-exchange resin.

### <<Liquid and Gas Usable for T-UFB-Containing Liquid>>

Now, the liquid W usable for generating the T-UFB-containing liquid is described. The liquid W usable in this embodiment is, for example, pure water, ion exchange water, distilled water, bioactive water, magnetic active water, lotion, tap water, sea water, river water, clean and sewage water, lake water, underground water, rain water, and so on. A mixed liquid containing the above liquid and the like is also usable. A mixed solvent containing water and soluble organic solvent can be also used. The soluble organic solvent to be used by being mixed with water is not particularly limited; however, the followings can be a specific example thereof. An alkyl alcohol group of the carbon number of 1 to 4 including methyl alcohol, ethyl alcohol, n-propyl alcohol, isopropyl alcohol, n-butyl alcohol, sec-butyl alcohol, and tert-butyl alcohol. An amide group including N-methyl-2-pyrrolidone, 2-pyrrolidone, 1,3-dimethyl-2-imidazolidinone, N,N-dimethylformamide, and N,N-dimethylacetamide. A keton group or a ketoalcohol group including acetone and diacetone alcohol. A cyclic ether group including tetrahydrofuran and dioxane. A glycol group including ethylene glycol, 1,2-propylene glycol, 1,3-propylene glycol, 1,2-butanediol, 1,3-butanediol, 1,4-butanediol, 1,5-pentanediol, 1,2-hexanediol, 1,6-hexanediol, 3-methyl-1,5-pentanediol, diethylene glycol, triethylene glycol, and thiodiglycol. A group of lower alkyl ether of polyhydric alcohol including ethylene glycol monomethyl ether, ethylene glycol monoethyl ether, ethylene glycol monobutyl ether, diethylene glycol monomethyl ether, diethylene glycol monoethyl ether, diethylene glycol monobutyl ether, triethylene glycol monomethyl ether, triethylene glycol monoethyl ether, and triethylene glycol monobutyl ether. A polyalkylene glycol group including polyethylene glycol and polypropylene glycol. A triol group including glycerin, 1,2,6-hexanetriol, and trimethylolpropane. These soluble organic solvents can be used individually, or two or more of them can be used together.

A gas component that can be introduced into the dissolving unit 200 is, for example, hydrogen, helium, oxygen, nitrogen, methane, fluorine, neon, carbon dioxide, ozone, argon, chlorine, ethane, propane, air, and so on. The gas component may be a mixed gas containing some of the above. Additionally, it is not necessary for the dissolving unit 200 to dissolve a substance in a gas state, and the dissolving unit 200 may fuse a liquid or a solid containing desired components into the liquid W. The dissolution in this case may be spontaneous dissolution, dissolution caused by pressure application, or dissolution caused by hydration, ionization, and chemical reaction due to electrolytic dissociation.

### <<Specific Example of Case of Using Ozone Gas>>

Here, as a specific example, a case of using ozone gas as the gas component is described. First, a method of generating ozone gas may include an electric discharge method, an electrolytic method, and an ultraviolet lamp method. The above methods are described below in sequence.

### (1) Electric Discharge Method

The electric discharge method includes a silent electric discharge method and a surface electric discharge method. In the silent electric discharge method, an alternating-current high voltage is applied while an oxygen-containing gas is flowed between a pair of electrodes arranged in the form of parallel flat plates or coaxial cylinders. With this, discharge occurs in the oxygen-containing gas, and ozone gas is generated. One of or both the surfaces of the pair of electrodes need to be covered with a dielectric such as glass. The discharge occurs in a gas (air or oxygen) in association with charges on the surface of the dielectric alternately varied positively and negatively.

On the other hand, in the surface electric discharge method, a surface of a flat plate-shaped electrode is covered with a dielectric such as ceramics, and a linear electrode is arranged on the surface of the dielectric. Then, an alternating-current high voltage is applied between the flat plate-shaped electrode and the linear electrode. With this, discharge occurs on the surface of the dielectric, and ozone gas is generated.

### (2) Electrolytic Method

A pair of electrodes with an electrolyte membrane arranged therebetween are arranged in water, and a direct-current voltage is applied between the two electrodes. With this, electrolysis of the water occurs, and ozone gas is generated with oxygen on the oxygen generation side. An ozone generator being practically used includes porous titanium having a platinum catalyst layer on a cathode, porous titanium having a lead dioxide catalyst layer on an anode, one using a perfluorosulfonic acid cation exchange membrane as an electrolyte membrane, and the like. According to the present apparatus, highly concentrated ozone of 20% by weight or greater can be generated.

### (3) Ultraviolet Lamp Method

Ozone gas is generated by exposing ultraviolet to the air and the like by using a similar principle as that of how the ozone layer of Earth is created. Usually, a mercury lamp is used as an ultraviolet lamp.

In a case of using ozone gas as the gas component, an ozone gas generating unit employing the methods (1) to (3) described above may be additionally added to the UFB generating apparatus 1 in FIG. 1.

Next, a method of dissolving the generated ozone gas is described. A method appropriate for dissolving ozone gas into the liquid W may include an “air bubble dissolution method”, a “membrane contactor dissolution method”, and a “filled-layer dissolution method” in addition to the pressurized dissolution method illustrated in FIGS. 3A and 3B. Hereinafter, the above three methods are compared with each other and described in sequence.

### (i) Air Bubble Dissolution Method

This is a method of mixing ozone gas into the liquid W as bubbles and flowing the ozone gas with the liquid W to dissolve. For example, there are a bubbling method in which ozone gas is blown from a lower portion of a container retaining the liquid W, an ejector method in which a narrow portion is provided in a part of a pipe through which the liquid W flows and ozone gas is blown into the narrow portion, a method of agitating the liquid W and the ozone gas by a pump, and the like. The air bubble dissolution method is a comparatively compact dissolution method and is used in a water treatment plant and the like.

### (ii) Membrane Contactor Dissolution Method

This is a method of absorbing and dissolving ozone gas into the liquid W by flowing the liquid W through a porous Teflon (registered trademark) membrane while the ozone gas is flowed through the outside.

(iii) Filled-Layer Dissolution Method

This is a method of dissolving ozone gas into the liquid W in a filled-layer by making counterflow of the ozone gas and the liquid by flowing the liquid W from the top of the filled-layer while flowing the ozone gas from the bottom.

In a case of employing the methods (i) to (iii) described above, the dissolving unit 200 of the UFB generating apparatus 1 may be changed from the one with the configuration illustrated in FIGS. 3A and 3B to the one with the configuration employing any one of the methods (i) to (iii).

Particularly, in terms of the severe toxicity, ozone gas with high purity is obligated to purchase with a gas cylinder and the usage is limited unless a special environment is prepared. For this reason, it is difficult to generate ozone microbubbles and ozone ultra-fine bubbles by conventional methods of generating microbubbles or ultra-fine bubbles by gas introduction (for example, a Venturi method, a swirl flow method, a pressurized dissolution method, and so on).

On the other hand, as a method of generating ozone dissolving water, a method of generating ozone from oxygen supplied by the above-described electric discharge method, electrolytic method, or ultraviolet lamp method and dissolving into the water concurrently with the ozone generation is useful from the points of the safety and the handleability.

However, in a case of employing a cavitation method and the like, although it is possible to generate ozone ultra-fine bubbles by using the ozone dissolving water, there are still problems such as an increase in size of the apparatus and the difficulty in increasing the concentration of the ozone ultra-fine bubbles.

In contrast, the T-UFB generating method of the present embodiment is better than the other generating methods such as the cavitation method in that the apparatus can be proportionally small in size, and highly concentrated ozone ultra-fine bubbles can be generated from the ozone dissolving water.

### <<Effects of T-UFB Generating Method>>

Next, the characteristics and the effects of the above-described T-UFB generating method are described by comparing with a conventional UFB generating method. For example, in a conventional air bubble generating apparatus as represented by the Venturi method, a mechanical depressurizing structure such as a depressurizing nozzle is provided in a part of a flow passage. A liquid flows at a predetermined pressure to pass through the depressurizing structure, and air bubbles of various sizes are generated in a downstream region of the depressurizing structure.

In this case, among the generated air bubbles, since the relatively large bubbles such as milli-bubbles and microbubbles are affected by the buoyancy, such bubbles rise to the liquid surface and disappear. Even the UFBs that are not affected by the buoyancy may also disappear with the milli-bubbles and microbubbles since the gas-liquid interface energy of the UFBs is not very large. Additionally, even if the above-described depressurizing structures are arranged in series, and the same liquid flows through the depressurizing structures repeatedly, it is impossible to store for a long time the UFBs of the number corresponding to the number of repetitions. In other words, it has been difficult for the UFB-containing liquid generated by the conventional UFB generating method to maintain the concentration of the contained UFBs at a predetermined value for a long time.

In contrast, in the T-UFB generating method of this embodiment utilizing the film boiling, a rapid temperature change from normal temperature to about 300° C. and a rapid pressure change from normal pressure to around a several megapascal occur locally in a part extremely close to the heating element. The heating element is a rectangular shape having one side of around several tens to hundreds of μm. It is around 1/10 to 1/1000 of the size of a conventional UFB generating unit. Additionally, with the gas-dissolved liquid within the extremely thin film region of the film boiling bubble surface exceeding the thermal dissolution limit or the pressure dissolution limit instantaneously (in an extremely short time under microseconds), the phase transition occurs and the gas-dissolved liquid is precipitated as the UFBs. In this case, the relatively large bubbles such as milli-bubbles and microbubbles are hardly generated, and the liquid contains the UFBs of about 100 nm in diameter with extremely high purity. Moreover, since the T-UFBs generated in this way have sufficiently large gas-liquid interface energy, the T-UFBs are not broken easily under the normal environment and can be stored for a long time.

Particularly, the present invention using the film boiling phenomenon that enables local formation of a gas interface in the liquid can form an interface in a part of the liquid close to the heating element without affecting the entire liquid region, and a region on which the thermal and pressure actions performed can be extremely local. As a result, it is possible to stably generate desired UFBs. With further more conditions for generating the UFBs applied to the generation liquid through the liquid circulation, it is possible to additionally generate new UFBs with small effects on the already-made UFBs. As a result, it is possible to produce a UFB liquid of a desired size and concentration relatively easily.

Moreover, since the T-UFB generating method has the above-described hysteresis properties, it is possible to increase the concentration to a desired concentration while keeping the high purity. In other words, according to the T-UFB generating method, it is possible to efficiently generate a long-time storable UFB-containing liquid with high purity and high concentration.

The method of dissolving ozone gas into the liquid W is described herein; however, a method of dissolving nitric oxide gas into the liquid W instead of ozone gas may be applied. Use of nitric oxide gas is also appropriate for medical and clinical application by using a biological activity function and the like.

Next, characteristic configurations and operations of the present disclosure are described based on first to fourth embodiments described below.

### First Embodiment

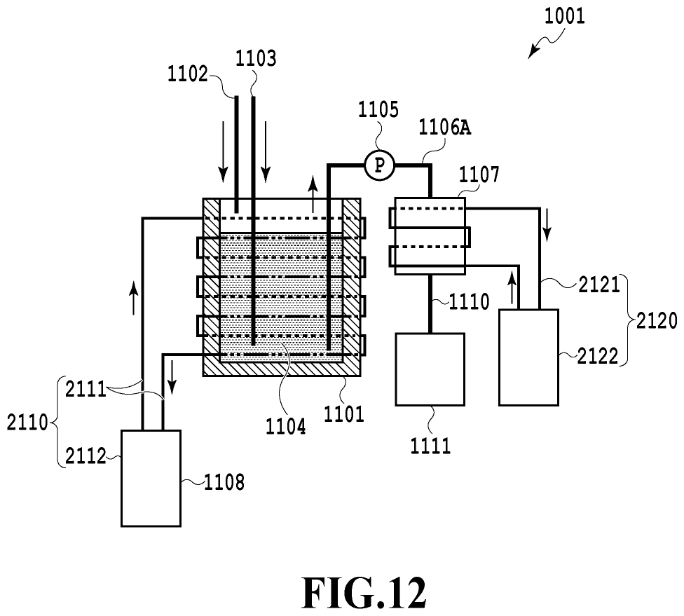

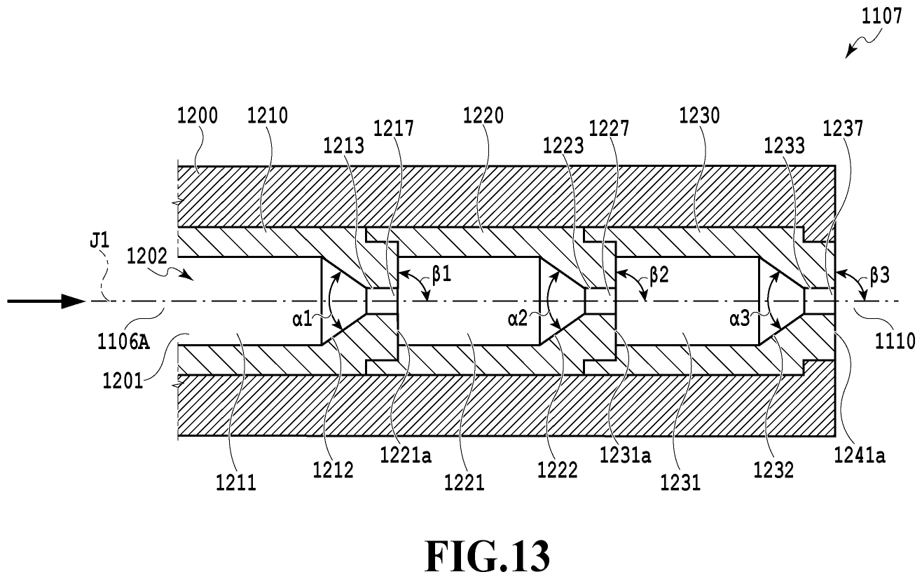

FIG. 12 is a schematic configuration diagram of an ultra-fine bubble-containing liquid generating apparatus (UFB-containing liquid generating apparatus) 1001 in the first embodiment. The UFB-containing liquid generating apparatus 1001 includes a gas dissolving tank 1101 including a dissolving unit that dissolves a predetermined gas into a liquid, and a UFB generating unit 1107 that generates UFBs in a gas dissolving liquid 1104 generated by the gas dissolving tank 1101. The UFB generating unit 1107 used in the present embodiment is different from the T-UFB generating unit 300 described in the above-described basic configuration and has a configuration including multiple (three) nozzle portions 1210, 1220, and 1230 illustrated in FIG. 13. The configuration of the UFB generating unit (ultra-fine bubble generating unit) 1107 is described below in detail with reference to FIG. 13.

A liquid introduction flow passage 1102 that introduces the liquid to the gas dissolving tank 1101 and a gas introduction flow passage 1103 that introduces the gas to the gas dissolving tank 1101 are coupled to the gas dissolving tank 1101. The gas dissolving tank 1101 generates a gas dissolving liquid 1104 by dissolving the gas introduced from the gas introduction flow passage 1103 into the liquid introduced from the liquid introduction flow passage 1102.

The gas dissolving liquid 1104 generated in the gas dissolving tank 1101 is transferred to the UFB generating unit 1107 by a pump 1105 through the inside of a gas dissolving liquid flow passage 1106A. The UFB generating unit 1107 generates the UFBs from the dissolved gas contained in the gas dissolving liquid. In this process, the amount of the generated UFBs is large as the amount of the dissolved gas contained in the gas dissolving liquid 1104 is large. With this taken into consideration, in order to set a low temperature state in which the solubility of the gas into the liquid is increased, a temperature controlling unit 2110 for gas dissolving tank (hereinafter, also referred to as a first temperature controlling unit) is disposed in the gas dissolving tank 1101. The first temperature controlling unit 2110 includes a coolant flow passage 2111 routed in an outer periphery of the gas dissolving tank 1101 and a coolant supplying unit 2112 that circulates a coolant such as an antifreeze liquid in the coolant flow passage 2111. The gas dissolving tank 1101 can be cooled by circulating the coolant in the coolant flow passage 2111. As the gas dissolving tank 1101 is cooled and thus the liquid introduced therein is cooled, the amount of the gas dissolved into the liquid is increased.

The first temperature controlling unit 2110 is not limited to have the above-described configuration using the coolant flow passage, and other configurations may be applied as long as it is a configuration capable of adjusting the temperature of the liquid in the gas dissolving tank 1101. Additionally, as long as the configuration of the gas dissolving tank 1101 is capable of dissolving the gas into the liquid, the shape, structure, and the like are not particularly limited.

In the UFB generating unit 1107, a temperature controlling unit 2120 for UFB generating unit (hereinafter, also referred to as a second temperature controlling unit) is disposed to control the temperature of the liquid to be equal to or lower than a temperature in the gas dissolving tank 1101. This is for inhibiting the gas dissolved by the gas dissolving tank 1101 from exceeding the saturation solubility of the gas and becoming air bubbles to precipitate in a case where the temperature of the UFB generating unit 1107 is higher than that of the gas dissolving tank 1101. The second temperature controlling unit 2120 may have a similar configuration as that of the first temperature controlling unit 2110. That is, the second temperature controlling unit 2120 can include a coolant flow passage 2121 routed in an outer periphery of the UFB generating unit 1107 and a coolant supplying unit 2122 that circulates a coolant in the coolant flow passage 2121. Note that, also the second temperature controlling unit 2120 may have other configurations as long as it is a configuration capable of controlling the temperature of the liquid in the UFB generating unit 1107.

In the present embodiment, the gas dissolving liquid flow passage 1106A that allows the gas dissolving tank 1101 and the UFB generating unit 1107 to communicate with each other is short, and it hardly affects substantially the temperature rise of the gas dissolving liquid 1104. For this reason, no temperature controlling unit is disposed in the gas dissolving liquid flow passage 1106A. The UFB-containing liquid generated in the UFB generating unit 1107 is injected into a container 1111 through an outlet port flow passage 1110. Since the outlet port flow passage 1110 and the container 1111 are a route through which the liquid passes after the UFBs are generated, the temperature controlling unit is not required to be disposed therein.

<Liquid and Gas Introduced into Gas Dissolving Tank>

As the liquid introduced into the gas dissolving tank 1101, for example, pure water, ion exchange water, distilled water, physiologically active water, magnetically active water, lotion, tap water, sea water, river water, clean water and sewage water, lake water, underground water, rainwater, and so on are usable. A mixed liquid including the above liquids and the like is also usable. A mixed solvent of water and a water-soluble organic solvent is also usable.

Although the water-soluble organic solvent to be mixed with water for use is not particularly limited, the followings can be a specific example thereof
alkyl alcohols of carbon number of one to four such as methyl alcohol, ethyl alcohol, n-propyl alcohol, isopropyl alcohol, n-butyl alcohol, sec-butyl alcohol, and tert-butyl alcohol.
amides such as N-methyl-2-pyrrolidone, 2-pyrrolidone, 1,3-dimethyl-2-imidazolidinone, N,N-dimethylformamide, and N,N-dimethylacetamide.
ketones or ketoalcohols such as acetone and diacetone alcohol.
cyclic ethers such as tetrahydrofuran and dioxane.
ethylene glycol, 1,2-propylene glycol, 1,3-propylene glycol.
glycols such as 1,2-butanediol, 1,3-butanediol, 1,4-butanediol, 1,5-pentanediol, 1,2-hexanediol, 1,6-hexanediol, 3-methyl-1,5-pentanediol, diethylene glycol, triethylene glycol, and thiodiglycol.
polyalcohol lower alkyl ethers such as ethylene glycol monomethyl ether, ethylene glycol monoethyl ether, ethylene glycol monobutyl ether, diethylene glycol monomethyl ether, diethylene glycol monoethyl ether, diethylene glycol monobutyl ether, triethylene glycol monomethyl ether, triethylene glycol monoethyl ether, and triethylene glycol monobutyl ether.
polyalkylene glycols such as polyethylene glycol and polypropylene glycol.
triols such as glycerin, 1,2,6-hexanetriol, and trimethylolpropane.

The above-described water-soluble organic solvent may be used independently or two or more types may be used in combination.

As the gas, for example, hydrogen, helium, oxygen, nitrogen, methane, fluorine, neon, carbon dioxide, ozone, argon, chlorine, ethane, propane, air, a mixed gas containing the above, and the like are usable.

### <UFB Generating Unit>

FIG. 13 is a vertical cross-sectional view illustrating a schematic configuration of the UFB generating unit 1107 in the present embodiment. The UFB generating unit 1107 has a configuration in which multiple nozzle portions are sequentially connected in a tubular outer periphery 1200. That is, in the outer periphery 1200, a first nozzle portion 1210, a second nozzle portion 1220, and a third nozzle portion 1230 each having a substantially cylindrical shape are stored while being connected sequentially from the gas dissolving liquid flow passage 1106A toward the outlet port flow passage 1110 (from upstream toward downstream). Although it is not particularly illustrated, the coolant flow passage 2121 of the second temperature controlling unit 2120 is routed in the outer periphery 1200.

In the first nozzle portion 1210, an introduction portion 1211, a first tapered portion 1212, and a first throat portion 1213 are continuously formed sequentially from the upstream side toward the downstream side of a nozzle flow passage 1202. In the second nozzle portion 1220, a first enlarged portion 1221, a second tapered portion 1222, and a second throat portion 1223 are provided. In the third nozzle portion 1230, a second enlarged portion 1231, a third tapered portion 1232, and a third throat portion 1233 are formed.

An inner surface of the introduction portion 1211 is a substantially cylindrical surface with a central axis J1 of the nozzle flow passage 1202 as the center, and the flow passage area of the introduction portion 1211 is substantially constant in a direction along the central axis J1. An upstream end of the first tapered portion 1212 communicates with a downstream end of the introduction portion 1211. A flow passage cross section at the upstream end of the first tapered portion 1212 coincides with a flow passage cross section at the downstream end of the introduction portion 1211. An inner surface of the first tapered portion 1212 has a substantially truncated cone shape with the central axis J1 as the center. The flow passage area of the first tapered portion 1212 is gradually reduced from the upstream toward the downstream of the nozzle flow passage 1202 (that is, toward a direction in which the gas dissolving liquid 1104 flows). In a vertical cross section including the central axis J1, an angle α1 formed by the inner surface of the first tapered portion 1212 and the central axis J1 is preferably 10° or greater and 90° or smaller.

An upstream end of the first throat portion 1213 is connected to a downstream end of the first tapered portion 1212. A flow passage cross section at the upstream end of the first throat portion 1213 coincides with a flow passage cross section at the downstream end of the first tapered portion 1212. An inner surface of the first throat portion 1213 is a substantially cylindrical surface with the central axis J1 as the center, and the flow passage area of the first throat portion 1213 is substantially constant in the central axis J1 direction. The flow passage area of the first throat portion 1213 is the smallest in the first nozzle portion 1210. The length of the first throat portion 1213 in the central axis J1 direction is preferably 1.1 times or more and 10 times or less of the diameter of the flow passage cross section of the first throat portion 1213 and is more preferably 1.5 times or more and 2 times or less thereof. In the following descriptions, the length of a flow passage in the central axis J1 direction is simply referred to as a “length”, and the diameter of a flow passage cross section is simply referred to as a “diameter”.

An opening at a downstream end of the first throat portion 1213 is a first jetting port 1217 that jets a fluid flowing from the first tapered portion 1212 into the first throat portion 1213 as a jet flow to the first enlarged portion 1221 of the second nozzle portion 1220 adjacent to the first jetting port 1217 on the downstream side. If a part of the flow passage area of the first nozzle portion 1210 is slightly changed, a portion having the smallest flow passage area affects the entire liquid fluidity of the first throat portion 1213.

The first enlarged portion 1221 is connected to the first jetting port 1217 of the first throat portion 1213, and the flow passage area is immediately enlarged from the first throat portion 1213. In a vertical cross section including the central axis J1, an angle (31 formed by a first surface 1221a of the first enlarged portion 1221 and the central axis J1 is preferably 45° or greater and 90° or smaller. In the present embodiment, the angle (31 formed by the first surface 1221a of the first enlarged portion 1221 and the central axis J1 is 90°. A flow passage cross section at an upstream end of the first enlarged portion 1221 is greater than the first jetting port 1217 of the first throat portion 1213, and a periphery of the flow passage cross section (opening portion at the upstream end of the first enlarged portion 1221) is positioned around the first jetting port 1217 to be away radially outward from the first jetting port 1217.

The second tapered portion 1222 is connected to a downstream end of the first enlarged portion 1221. A flow passage cross section at an upstream end of the second tapered portion 1222 coincides with a flow passage cross section of the downstream end of the first enlarged portion 1221. An inner surface of the second tapered portion 1222 has a substantially truncated cone shape with the central axis J1 as the center. The flow passage area of the second tapered portion 1222 is gradually reduced from the upstream toward the downstream. In a cross section including the central axis J1, an angle α2 formed by the inner surface of the second tapered portion 1222 is preferably 10° or greater and 90° or smaller.

The second throat portion 1223 communicates with a downstream end of the second tapered portion 1222. A flow passage cross section at an upstream end of the second throat portion 1223 coincides with a flow passage cross section at the downstream end of the second tapered portion 1222. An inner surface of the second throat portion 1223 is a substantially cylindrical surface with the central axis J1 as the center, and the flow passage area of the second throat portion 1223 is substantially constant. The flow passage area of the second throat portion 1223 is the smallest in the second nozzle portion 1220. The length of the second throat portion 1223 is preferably 1.1 times or more and 10 times or less of the diameter of the second throat portion 1223 and is more preferably 1.5 times or more and 2 times or less thereof.

An opening at a downstream end of the second throat portion 1223 is a second jetting port 1227 that jets a fluid flowing from the second tapered portion 1222 toward the second throat portion 1223 as a jet flow to the second enlarged portion 1231 of the third nozzle portion 1230 adjacent to the second jetting port 1227 on the downstream side. If a part of the flow passage area of the second nozzle portion 1220 is slightly changed, a portion having the smallest flow passage area affects the entire liquid fluidity of the second throat portion 1223.

The second enlarged portion 1231 is connected to the second jetting port 1227 of the second throat portion 1223, and the flow passage area is immediately enlarged from the second throat portion 1223. In a vertical cross section including the central axis J1, an angle β2 formed by a first surface 1231a of the second enlarged portion 1231 and the central axis J1 is preferably 45° or greater and 90° or smaller. In the present embodiment, the angle β2 formed by the first surface 1231a of the second enlarged portion 1231 and the central axis J1 is 90°. A flow passage cross section at an upstream end of the second enlarged portion 1231 is greater than the second jetting port 1227 of the second throat portion 1223, and an outer peripheral edge of the flow passage cross section (opening portion at the upstream end of the second enlarged portion 1231) is positioned around the second jetting port 1227 to be away radially outward from the second jetting port 1227.

An upstream end of the third tapered portion 1232 is connected to a downstream end of the second enlarged portion 1231. A flow passage cross section at the upstream end of the third tapered portion 1232 coincides with a flow passage cross section at the downstream end of the second enlarged portion 1231. An inner surface of the third tapered portion 1232 has a substantially truncated cone shape with the central axis J1 as the center. The flow passage area of the third tapered portion 1232 is gradually reduced from the upstream toward the downstream. In a vertical cross section including the central axis J1, an angle α3 formed by the inner surface of the third tapered portion 1232 is preferably 10° or greater and 90° or smaller.

An upstream end of the third throat portion 1233 is connected to a downstream end of the third tapered portion 1232. A flow passage cross section at the upstream end of the third throat portion 1233 coincides with a flow passage cross section at the downstream end of the third tapered portion 1232. An inner surface of the third throat portion 1233 is a substantially cylindrical surface with the central axis J1 as the center, and a flow passage area of the third throat portion 1233 is substantially constant. The flow passage area of the third throat portion 1233 is the smallest in the third nozzle portion 1230. The length of the third throat portion 1233 is preferably 1.1 times or more and 10 times or less of the diameter of the third throat portion 1233 and is more preferably 1.5 times or more and 2 times or less thereof.

An opening at a downstream end of the third throat portion 1233 is a third jetting port 1237 that jets a fluid flowing from the third tapered portion 1232 into the third throat portion 1233 as a jet flow to the downstream side. If a part of the flow passage area of the third nozzle portion 1230 is slightly changed, a portion having the smallest flow passage area affects the entire liquid fluidity of the third throat portion 1233. Preferably, the diameter of the third throat portion 1233 is equal to or greater than the diameter of the second throat portion 1223, and the diameter of the second throat portion 1223 is equal to or greater than the diameter of the first throat portion 1213.

In the present embodiment, the first tapered portion 1212, the second tapered portion 1222, and the third tapered portion 1232 have the same shape. The first enlarged portion 1221 and the second enlarged portion 1231 have the same shape. The diameters of the introduction portion 1211, the first enlarged portion 1221, and the second enlarged portion 1231 are about 4 to 5 times as great as the diameter of the first throat portion 1213, the diameter of the second throat portion 1223, and the diameter of the third throat portion 1233, respectively. Each diameter of the first throat portion 1213, the second throat portion 1223, and the third throat portion 1233 is desirably increased from the upstream toward the downstream, and more desirably, the increase rate of the increase in the diameter is desirably at 7% or less. In this case, the increase rate indicates a ratio expressed by the following expression.

Increase rate=(diameter of downstream throat portion−diameter of upstream throat portion)/diameter of downstream throat portion×100(%)

In the above expression, for example, if the upstream throat portion is the first throat portion 1213, the downstream throat portion is the second throat portion 1223, and if the upstream throat portion is second throat portion 1223, the downstream throat portion is the third throat portion 1233.

In the UFB generating unit 1107 having the above-described configuration, the gas dissolving liquid 1104 flowing into the nozzle flow passage 1202 from a nozzle inlet port 1201 flows into the first throat portion 1213 while gradually accelerating in the first tapered portion 1212. The flow velocity of the gas dissolving liquid 1104 in the first throat portion 1213 is preferably 7 to 30 m per second. In the first throat portion 1213, the static pressure of the gas dissolving liquid 1104 is reduced. Accordingly, the gas (dissolved gas) dissolved in the gas dissolving liquid 1104 exceeds the saturation solubility of the gas and precipitates into the liquid as fine air bubbles. The liquid containing the fine air bubbles (fine air bubble-containing liquid) is jetted as a jet flow from the first jetting port 1217 toward the first enlarged portion 1221.

The precipitation of the fine air bubbles continues also in the fine air bubble-containing liquid jetted to the first enlarged portion 1221. The fine air bubbles are made finer by shear force and the like generated in the first enlarged portion 1221 by the jet flow from the first jetting port 1217. The fine air bubble-containing liquid flowing through the first enlarged portion 1221 flows into the second throat portion 1223 while gradually accelerating in the second tapered portion 1222 and is jetted as a jet flow from the second jetting port 1227 toward the second enlarged portion 1231. The fine air bubbles contained in the fine air bubble-containing liquid jetted to the second enlarged portion 1231 is made finer by shear force and the like generated in the second enlarged portion 1231 by the jet flow.

The fine air bubble-containing liquid flowing through the second enlarged portion 1231 flows into the third throat portion 1233 while gradually accelerating in the third tapered portion 1232 and is jetted as a jet flow from the third jetting port 1237 toward the outlet port flow passage 1110. The fine air bubbles in the fine air bubble-containing liquid are made finer by shear force and the like generated in the third enlarged portion 1234 by the jet flow, and thus a UFB-containing liquid containing many UFBs smaller than 1 μm in diameter is generated.

### Example (1) of Generating UFB-Containing Liquid

In the above-described UFB generating apparatus, the first temperature controlling unit 2110 and the second temperature controlling unit 2120 need to control the gas dissolving tank 1101 and the UFB generating unit 1107 within a higher temperature range than the coagulation point of the gas dissolving liquid in order to avoid the coagulation (freezing) of the gas dissolving liquid. The temperature range as the control target is preferably a range from the coagulation point of the gas dissolving liquid to a temperature higher than the coagulation point 15° C. or more, and more preferably, the temperature range is a range to a temperature higher than the coagulation point of the gas dissolving liquid 10° C. or more. The temperature of the UFB generating unit 1107 is preferably controlled to be lower than the temperature of the gas dissolving tank 1101 2° C. or more, and more preferably, the temperature of the UFB generating unit 1107 is controlled to be lower than the temperature of the gas dissolving tank 1101 5° C. or more.

In the present embodiment, in the UFB generating apparatus, the temperature of the gas dissolving tank 1101 was set to 10° C. by the first temperature controlling unit 2110, and the temperature of the UFB generating unit 1107 was set to 5° C. by the second temperature controlling unit 2120. Under the temperature conditions, the UFBs were generated, and the UFB concentration was measured. The temperature of the gas dissolving tank 1101 in the present embodiment was measured by disposing a sensor in the liquid in the gas dissolving tank 1101. The temperature of the UFB generating unit 1107 was measured by disposing a sensor on the upstream side of the gas dissolving liquid flow passage 1106A.

The liquid used was pure water, and oxygen was used as the gas dissolved in the pure water. The amount of the pure water introduced into the gas dissolving tank 1101 was 10 L. In the gas dissolving tank 1101, oxygen was introduced at a flow rate of about 100 mL/min, bubbling was performed in the gas dissolving tank 1101 for an hour to dissolve oxygen into the pure water and make a gas dissolving liquid, and thus an oxygen dissolving water was generated.

After the bubbling for an hour, the amount of the dissolved oxygen in the oxygen dissolving water was measured by a dissolved oxygen analyzer. As a result, the amount of the dissolved oxygen in the oxygen dissolving water was 54 mg/L. In contrast, the measured value of the amount of the dissolved oxygen contained in the pure water at the normal temperature before the oxygen dissolution was 8 mg/L. Accordingly, it was found that sufficient oxygen was dissolved in the oxygen dissolving water generated by the oxygen dissolving processing in the gas dissolving tank 1101 in the present embodiment.

Next, the oxygen dissolving water as the gas dissolving liquid was introduced into the UFB generating unit 1107 at a flow rate of about 1 L/min, and the UFB-containing liquid was generated in the oxygen dissolving water passing through the UFB generating unit 1107. As described above, since the UFB generating unit 1107 was set to be 5° C. lower than the set temperature of the gas dissolving tank 1101, oxygen dissolved in the gas dissolving tank 1101 did not reach the saturation state in the UFB generating unit 1107, and almost all the oxygen was used for the UFB generating. Thereafter, the UFB-containing liquid generated by the UFB generating unit 1107 passed through the discharge route 10 and was stored in the container 1111.

The concentration of the generated UFB-containing liquid stored in the container 1111 was measured by using SALD7500nano (manufactured by SHIMADZU CORPORATION). As a result, in the UFB-containing liquid generated, it was confirmed that the concentration of the UFBs of 1 μm or smaller was about 100 hundred million pieces/mL, and the average particle diameter of the UFBs was 110 nm.

### Second Embodiment

### <UFB-Containing Liquid Generating Apparatus>

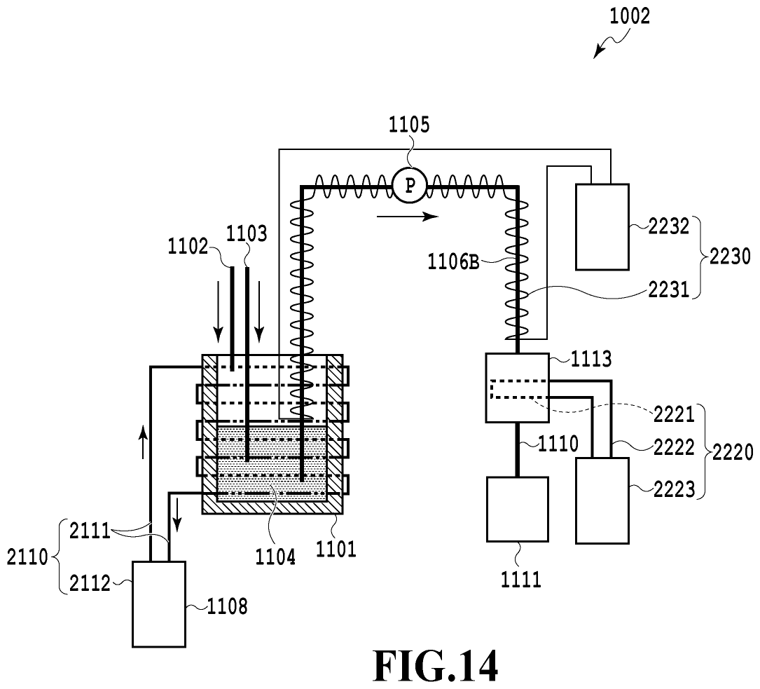

FIG. 14 is a schematic configuration diagram of a UFB-containing liquid generating apparatus 1002 in a second embodiment of the present disclosure. The UFB-containing liquid generating apparatus 1002 includes the gas dissolving tank 1101, the first temperature controlling unit 2110 that is the temperature controlling unit for gas dissolving tank, a UFB generating unit 1113, and the container 1111. Additionally, the UFB-containing liquid generating apparatus 1002 includes a second temperature controlling unit 2220 that is a temperature controlling unit for UFB generating unit, a gas dissolving liquid flow passage (first flow passage) 1106B, and a temperature controlling unit 2230 for gas dissolving liquid flow passage. The gas dissolving tank 1101, the first temperature controlling unit 2110 that is a temperature controlling unit for gas dissolving tank, and the container 1111 are similar to those illustrated in the first embodiment. However, the first embodiment and the present embodiment are different in the following points.

The UFB generating unit 1113 in the UFB-containing liquid generating apparatus 1002 in the present embodiment employs the T-UFB generating method described in the above-described basic configuration. In the UFB generating unit 1113, the temperature controlling unit (second temperature controlling unit) 2220 for UFB generating unit is provided. The UFB generating unit 1113 and the second temperature controlling unit 2220 are described later.

In the present embodiment, the temperature controlling unit 2230 for gas dissolving liquid flow passage that controls the temperature of the gas dissolving liquid flow passage 1106B transferring the gas dissolving liquid generated in the gas dissolving tank 1101 to the UFB generating unit 1113 is provided. Configurations of units in the UFB-containing liquid generating apparatus 1002 in the second embodiment are described below in more detail while focusing on the different points from the first embodiment.

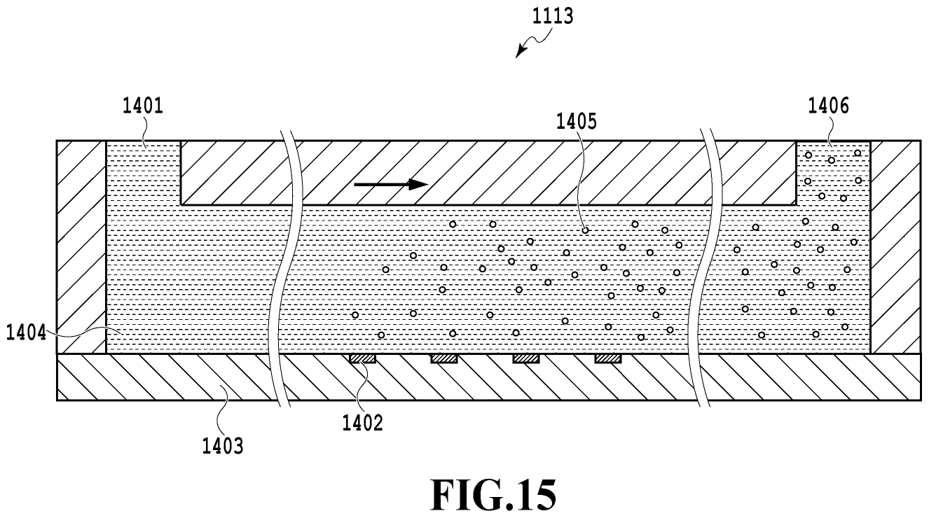

FIG. 15 is a cross-sectional view schematically illustrating a configuration of the UFB generating unit 1113 in the present embodiment. As illustrated in FIG. 15, in the UFB generating unit 1113, a UFB generating flow passage 1404 from an inlet 1401 to an outlet 1406 is formed. The inlet 1401 is connected at a downstream end of the gas dissolving liquid flow passage 1106B. The outlet 1406 is positioned at a downstream end of the UFB generating flow passage 1404 and connected at an upstream end of the outlet port flow passage 1110 connected to the container 1111. An element substrate 1403 including heating elements (heaters) 1402 is arranged on a bottom portion of the UFB generating flow passage 1404. The element substrate 1403 has a similar configuration as that of the element substrate 12 described with reference to FIG. 5A in the above-described basic configuration; for this reason, the description is omitted.

In the UFB generating unit 1113 having the above-described configuration, the gas dissolving liquid 1104 generated in the gas dissolving tank 1101 is introduced from the inlet 1401 to the UFB generating flow passage 1404 by way of the gas dissolving liquid flow passage 1106B. The gas dissolving liquid 1104 introduced in the UFB generating flow passage 1404 is heated by the heating elements 1402 while passing through the element substrate 1403, and film boiling occurs. Consequently, UFBs 1405 are generated in the gas dissolving liquid 1104, and the UFB-containing liquid is generated. The UFB-containing liquid generated in the UFB generating flow passage 1404 is transferred to the outlet port flow passage 1110 from the outlet 1406 and stored in the container 1111.

### <Temperature Controlling Unit>

### <<Temperature Controlling Unit for UFB Generating Unit (Second Temperature Controlling Unit)>>

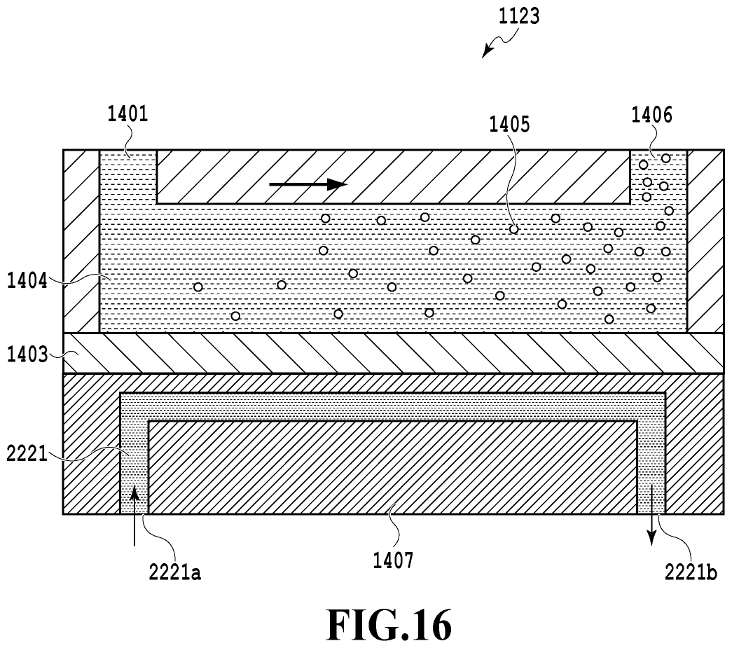

FIG. 16 is a cross-sectional view schematically illustrating a coolant flow passage 2221 forming a part of the temperature controlling unit 2220 for UFB generating unit (second temperature controlling unit) that performs temperature control of the UFB generating unit 1113 in the present embodiment. In FIG. 16, the coolant flow passage 2221 is formed in a base plate 1407 on which the element substrate 1403 is arranged. An inlet 2221a and an outlet 2221b of the coolant flow passage 2221 are coupled to a coolant supplying unit 2223 illustrated in FIG. 14 via a coupling flow passage 2222. The coolant flowing out from the coolant supplying unit 2223 flows into the coolant flow passage 2221 from the inlet 2221a by way of the coupling flow passage 2222. The coolant cools the base plate 1407 while passing through the coolant flow passage 2221. Thereafter, the coolant returns to the coolant supplying unit 2223 from the outlet 2221b by way of the coupling flow passage 2222 and is cooled by the coolant supplying unit 2223. Then, the coolant flows into the coolant flow passage 2221 again by way of the coupling flow passage 2222. Thus, the second temperature controlling unit 2220 in the present embodiment flows the coolant in the base plate 1407 in direct contact with the element substrate 1403 in which the temperature is raised by the heating elements 1402 (FIG. 15). Therefore, the temperature of the UFB generating flow passage 1404 in the UFB generating unit 1113 can be maintained at a predetermined temperature while effectively suppressing the temperature rise in the element substrate 1403.

### <<Temperature Controlling Unit for Gas Dissolving Liquid Flow Passage (Third Temperature Controlling Unit)>>

Referring back to FIG. 14 to give descriptions. In the present embodiment, here is provided the temperature controlling unit 2230 for gas dissolving liquid flow passage (hereinafter, also referred to as a third temperature controlling unit that controls the temperature of the gas dissolving liquid flow passage 1106B from the gas dissolving tank 1101 to the UFB generating unit 1113. The third temperature controlling unit 2230 includes a coolant flow passage 2231 arranged around the gas dissolving liquid flow passage 1106B and a coolant supplying unit 2232 that circulates a coolant in the coolant flow passage 2231. The gas dissolving liquid flow passage 1106B can be cooled by flowing the coolant, which is transferred from the coolant supplying unit 2232, into the coolant flow passage 2231 arranged around the gas dissolving liquid flow passage 1106B. Accordingly, even in a case where the gas dissolving liquid flow passage 1106B is a flow passage that is longer than a predetermined length and is likely to be affected by an environmental temperature, the temperature rise of the gas dissolving liquid transferred from the gas dissolving tank 1101 can be suppressed by the third temperature controlling unit 2230. Therefore, it is possible to suppress the precipitation of the dissolved gas from the gas dissolving liquid until the gas dissolving liquid generated by the gas dissolving tank 1101 reaches the UFB generating unit 1113.

### Example (2) of Generating UFB-Containing Liquid

The UFB-containing liquid generating apparatus of the present embodiment having the above-described configuration was used to generate the UFBs under the conditions described below and measure the UFB concentration. The temperature of the gas dissolving tank 1101 was measured by disposing a sensor in the liquid in the gas dissolving tank 1101. The temperature of the UFB generating unit 1113 was measured by disposing a sensor on an upstream side of the inlet 1401 of the UFB generating flow passage 1404.

The liquid used was pure water, and oxygen was used as the gas dissolved in the pure water. The amount of the pure water introduced into the gas dissolving tank 1101 was 10 L, and the temperature of the gas dissolving tank 1101 was set at 10° C. Oxygen was introduced into the gas dissolving tank 1101 at a flow rate of about 100 mL/min, bubbling was performed in the gas dissolving tank 1101 for an hour to dissolve oxygen into the pure water. As a result of measuring by a dissolved oxygen analyzer, the amount of the dissolved oxygen in the generated oxygen dissolving water was 54 mg/L.

Next, the oxygen dissolving water was introduced into the UFB generating unit 1113 at a flow rate of about 1 L/min, and the UFB-containing liquid was generated. In this process, the number of the heating elements 1402 in the UFB generating unit 1113 was 100,000 pieces, the driving frequency of the heating elements 1402 was 20 kHz, the pulse width of the pulse signal applied to the driving heating elements was 1.0 μsec, the pulse voltage was 24V, and the temperature of the UFB generating unit 1113 was 5° C. The generated UFB-containing liquid passed through the outlet port flow passage 1110 and was stored in the container 1111.

The UFB concentration in the UFB-containing liquid generated was measured by SALD7500nano (manufactured by SHIMADZU CORPORATION). As a result, it was confirmed that the concentration of the UFBs of 1 μm or smaller contained in the UFB-containing liquid was about 1.4 billion pieces/mL, and the average particle diameter was 110 nm.

### Example (3) of Generating UFB-Containing Liquid

In the UFB-containing liquid generating apparatus of the present embodiment, the UFBs were generated while setting the temperature of the gas dissolving tank 1101 at 5° C. and the temperature of the UFB generating unit 1113 at 3° C. The conditions other than the temperatures were all the same as that of <Example (2) of Generating UFB-Containing Liquid> described above.

The UFB concentration in the UFB-containing liquid generated was measured by SALD7500nano (manufactured by SHIMADZU CORPORATION). As a result, it was confirmed that the concentration of the UFBs of 1 μm or smaller contained in the UFB-containing liquid was about 1.6 billion pieces/mL, and the average particle diameter was 110 nm.

### Third Embodiment

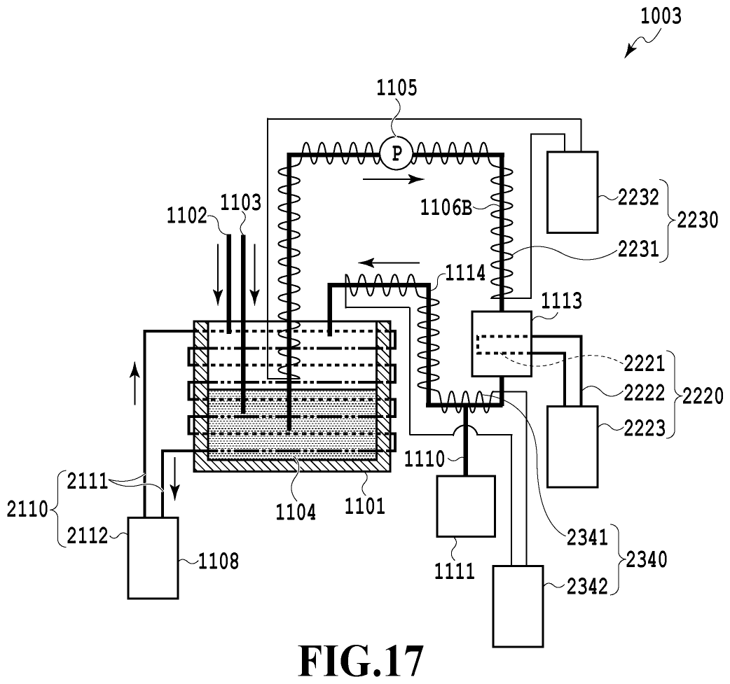

FIG. 17 is a schematic configuration diagram of a UFB-containing liquid generating apparatus 1003 in a third embodiment of the present disclosure. The UFB-containing liquid generating apparatus 1003 in the present embodiment has a configuration that is the configuration of the above-described UFB-containing liquid generating apparatus 1002 illustrated in the above-described second embodiment to which a circulation flow passage (second flow passage) 1114 for putting back the UFB-containing liquid generated in the UFB generating unit 1113 to the gas dissolving tank 1101 is added. The circulation flow passage 1114 is coupled to the outlet port flow passage 1110 via a not-illustrated switching valve so as to be able to selectively switch the transfer destination of the UFB-containing liquid generated in the UFB generating unit 1113 to the gas dissolving tank 1101 or the container 1111.

In the circulation flow passage 1114, a temperature controlling unit 2340 for circulation flow passage is provided. The fourth temperature controlling unit 2340 includes a coolant flow passage 2341 arranged around the circulation flow passage 1114 and a coolant supplying unit 2342 that circulates a coolant in the coolant flow passage 2341. The temperature controlling unit 2340 makes it possible to suppress the temperature rise in the circulation flow passage 1114 of the UFB-containing liquid generated in the UFB generating unit 1113.

### Example (4) of Generating UFB-Containing Liquid

The UFB-containing liquid generating apparatus 1003 of the present embodiment having the above-described configuration was used to generate the UFB-containing liquid by continuing operation of the apparatus until the liquid in the gas dissolving tank 1101 was circulated five times, and thereafter, the UFB-containing liquid was stored into the container 1111 by way of the outlet port flow passage 1110. The temperature conditions to generate the UFB-containing liquid were the same as that of <Example (2) of Generating UFB-Containing Liquid> in the above-described second embodiment.

The concentration of the generated UFBs in the UFB-containing liquid generated was measured by SALD7500nano (manufactured by SHIMADZU CORPORATION). As a result, it was confirmed that the concentration of the UFBs of 1 μm or smaller contained in the UFB-containing liquid was about 4 billion pieces/mL, and the average particle diameter was 110 nm.

### Fourth Embodiment

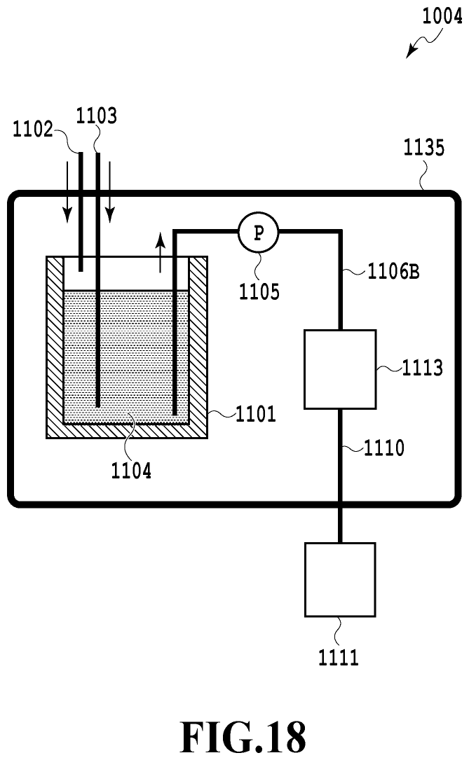

FIG. 18 is a schematic configuration diagram of a UFB-containing liquid generating apparatus 1004 in a fourth embodiment of the present disclosure. The UFB-containing liquid generating apparatus 1004 in the present embodiment includes the gas dissolving tank 1101 and the UFB generating unit 1113 having similar configurations as that in the second embodiment and a storing chamber 1135 storing the gas dissolving tank 1101 and the UFB generating unit 1113. The storing chamber 1135 includes a not-illustrated temperature controlling unit (fourth temperature controlling unit) so as to able to control the temperature of a region including the gas dissolving tank 1101 and the UFB generating unit 1113.

Thus, since the gas dissolving tank 1101 and the UFB generating unit 1113 exist in the same region in the storing chamber 1135, the temperatures of the gas dissolving tank 1101 and the UFB generating unit 1113 are the same. In the present embodiment, the second temperature controlling unit 2220 and the third temperature controlling unit 2230 described in the second embodiment are not provided.

### Example (5) of Generating UFB-Containing Liquid

The UFB-containing liquid generating apparatus 1004 having the above-described configuration was used to generate the UFB-containing liquid while setting the conditions other than the temperature conditions the same as that of the second embodiment. The temperatures of the gas dissolving tank 1101 and the UFB generating unit 1113 during the UFB generating were set at 5° C. by the temperature controlling unit in the storing chamber 1135.

The UFB concentration in the UFB-containing liquid generated was measured by SALD7500nano (manufactured by SHIMADZU CORPORATION). As a result, it was confirmed that the concentration of the UFBs of 1 μm or smaller contained in the UFB-containing liquid was about 1.2 billion pieces/mL, and the average particle diameter was 110 nm.

As described above, sufficient UFB generating concentration and average particle diameter can be obtained also in the present embodiment. However, the UFB concentration of the UFB-containing liquid generated in the present embodiment is lower than the UFB concentration of the UFB-containing liquid generated in <Example (2) of Generating UFB-Containing Liquid> in the second embodiment. It can be considered that this is because of the following reasons.

In the present embodiment, since the gas dissolving tank 1101 and the UFB generating unit 1113 are controlled at the same spatial temperature, a slight temperature rise occurs in the UFB generating unit 1113 by an effect of the heating elements 1402 and the like. In this case, the dissolved oxygen that exceeds the saturation solubility is gasified in the gas dissolving liquid, and the dissolved oxygen contained in the gas dissolving liquid is reduced. It can be considered that this causes the reduction in the UFB concentration of the UFB-containing liquid generated in the present embodiment.

### Comparative Example

Here is described a comparative example of the second embodiment. In the comparative example, the UFB-containing liquid generating apparatus 1002 having the same configuration described in the second embodiment is used to generate the UFB-containing liquid by setting both the temperatures of the gas dissolving tank 1101 and UFB generating unit 1113 at a normal temperature (25° C.). The conditions other than the temperatures are the same as that of <Example (2) of Generating UFB-Containing Liquid> in the second embodiment.

The concentration of the generated UFBs in the UFB-containing liquid generated was measured by SALD7500nano (manufactured by SHIMADZU CORPORATION). As a result, it was confirmed that the concentration of the UFBs of 1 μm or smaller in the generated UFB-containing liquid was about 1 billion pieces/mL, and the average particle diameter was 110 nm. From this result, it was found that it is possible to efficiently generate a highly concentrated UFB-containing liquid by performing temperature control like the above-described embodiment.

### Other Embodiments

In the above-described embodiments, examples of using the method of using a nozzle portion and the T-UFB generating method are described as the UFB generating method in the UFB generating unit; however, it is not limited thereto. The present embodiment is also effective in a case of using another UFB generating method.

In the above-described embodiments, an example of performing temperature control using a corresponding temperature controlling unit if there are provided multiple temperature controlling units is described; however, it is not limited thereto. Even there are provided multiple temperature controlling units, the temperature of the UFB generating unit may be controlled to be equal to or lower than the temperature of the gas dissolving tank by executing at least the temperature control by the temperature controlling unit cooling the UFB generating unit. As long as the UFB generating unit is sufficiently cooled, the temperature of the UFB generating unit may be controlled to be equal to or lower than the temperature of the gas dissolving tank by executing the temperature control of the gas dissolving tank.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2021-066520, filed Apr. 9, 2021, which is hereby incorporated by reference wherein in its entirety.

What is claimed is:

1. An ultra-fine bubble-containing liquid generating apparatus, comprising:
a dissolving unit that generates a gas dissolving liquid in which a predetermined gas is dissolved into a liquid;
an ultra-fine bubble generating unit that generates an ultra-fine bubble in the gas dissolving liquid; and
a temperature controlling unit that controls at least one of temperatures of the dissolving unit and the ultra-fine bubble generating unit such that the temperature of the ultra-fine bubble generating unit is equal to or lower than the temperature of the dissolving unit.

2. The ultra-fine bubble-containing liquid generating apparatus according to claim 1, wherein
the temperature controlling unit includes a first temperature controlling unit that controls the temperature of the dissolving unit and a second temperature controlling unit that controls the temperature of the ultra-fine bubble generating unit, and
the first temperature controlling unit and the second temperature controlling unit are able to control a temperature independently from each other.

3. The ultra-fine bubble-containing liquid generating apparatus according to claim 1, wherein
the temperature controlling unit includes a third temperature controlling unit that controls a temperature of a first flow passage that transfers the gas dissolving liquid generated by the dissolving unit to the ultra-fine bubble generating unit.

4. The ultra-fine bubble-containing liquid generating apparatus according to claim 1, wherein
a second flow passage that circulates a liquid between the dissolving unit and the ultra-fine bubble generating unit is formed, and
the temperature controlling unit controls a temperature of the second flow passage.

5. The ultra-fine bubble-containing liquid generating apparatus according to claim 1, further comprising:
a storing chamber that stores the dissolving unit and the ultra-fine bubble generating unit in the same region, wherein
the temperature controlling unit includes a fourth temperature controlling unit that controls a temperature of the region.

6. The ultra-fine bubble-containing liquid generating apparatus according to claim 1, wherein
the temperature controlling unit controls the temperature of the dissolving unit and the temperature of the ultra-fine bubble generating unit such that the temperatures are within a temperature range higher than a coagulation point of the gas dissolving liquid.

7. The ultra-fine bubble-containing liquid generating apparatus according to claim 6, wherein
the temperature range is a range from the coagulation point of the gas dissolving liquid to a temperature higher than the coagulation point 10° C. or more.

8. The ultra-fine bubble-containing liquid generating apparatus according to claim 6, wherein
the temperature range is a range from the coagulation point of the gas dissolving liquid to a temperature higher than the coagulation point 15° C. or more.

9. The ultra-fine bubble-containing liquid generating apparatus according to claim 1, wherein
the temperature controlling unit controls the temperature of the ultra-fine bubble generating unit so as to be lower than the temperature of the dissolving unit 2° C. or more.

10. The ultra-fine bubble-containing liquid generating apparatus according to claim 1, wherein
the temperature controlling unit controls the temperature of the ultra-fine bubble generating unit so as to be lower than the temperature of the dissolving unit of the gas 5° C. or more.

11. The ultra-fine bubble-containing liquid generating apparatus according to claim 1, wherein
the ultra-fine bubble generating unit generates ultra-fine bubbles by generating film boiling in the gas dissolving liquid.

12. The ultra-fine bubble-containing liquid generating apparatus according to claim 1, wherein
the ultra-fine bubble generating unit generates the ultra-fine bubbles by jetting the gas dissolving liquid from at least one nozzle portion.

13. The ultra-fine bubble-containing liquid generating apparatus according to claim 12, wherein
the ultra-fine bubble generating unit includes a plurality of nozzles arranged along a predetermined direction, and a first nozzle portion positioned on an upstream side in the predetermined direction jets the gas dissolving liquid to a second nozzle portion adjacent to the first nozzle portion on a downstream side in the predetermined direction.

14. An ultra-fine bubble-containing liquid generating method, characterized by:
comprising a dissolving unit that generates a gas dissolving liquid in which a predetermined gas is dissolved into a liquid and an ultra-fine bubble generating unit that generates an ultra-fine bubble in the gas dissolving liquid are included; and
controlling at least one of temperatures of the dissolving unit and the ultra-fine bubble generating unit such that the temperature of the ultra-fine bubble generating unit is equal to or lower than the temperature of the dissolving unit.

15. An ultra-fine bubble-containing liquid generated by an ultra-fine bubble-containing liquid generating apparatus including a dissolving unit that generates a gas dissolving liquid in which a predetermined gas is dissolved into a liquid and an ultra-fine bubble generating unit that generates an ultra-fine bubble in the gas dissolving liquid, characterized in that
the ultra-fine bubble-containing liquid is generated by controlling at least one of temperatures of the dissolving unit and the ultra-fine bubble generating unit such that the temperature of the ultra-fine bubble generating unit is equal to or lower than the temperature of the dissolving unit.
